(19) United States
(12) Patent Application Publication
(10) Pub. No.: US 2024/0103231 A1
(43) Pub. Date: Mar. 28, 2024

(54) FIBER OPTIC CONNECTORS HAVING A WEATHERPROOFING COLLAR

(71) Applicant: CORNING RESEARCH & DEVELOPMENT CORPORATION, Corning, NY (US)

(72) Inventors: Stephen Paul Cappannari, Mooresville, NC (US); Michael De Jong, Colleyville, TX (US); Ashley Wesley Jones, Denton, TX (US); Przemyslaw Andrzej Kukian, Lodz (PL); Jun Ma, Pittsford, NY (US); Gordon Mueller-Schlomka, Berlin (DE); Shane Chad Woody, Mooresville, NC (US)

(21) Appl. No.: 18/140,101

(22) Filed: Apr. 27, 2023

Related U.S. Application Data
(63) Continuation of application No. PCT/US2021/056980, filed on Oct. 28, 2021.
(60) Provisional application No. 63/107,962, filed on Oct. 30, 2020.

(51) Int. Cl. G02B 6/38

(52) U.S. Cl. CPC G02B 6/3849; G02B 6/38875; G02B 6/3893

(57) ABSTRACT

Female fiber optic connectors having a weatherproofing collar disposed rearward of a connection port opening that receives a fiber optic plug along with cable assemblies comprising the female fiber optic connector and with methods of making the same. The female fiber optic connectors comprise an actuator such as a rocker latch arm or the like disposed under the weatherproofing collar used for releasing or securing an external fiber optic plug that may be received in the connection port. The weatherproofing collar protects the actuator such as the rocker arm latch and surrounding area from dirt, debris, moisture and the like from ingress into the connector. One or more end caps may be used with the weatherproofing collar. The weatherproofing collar allows for a ruggedized fiber optic connector having a quick connect and release mechanism for the external fiber optic plug connector mated to the female fiber optic connector.

### CROSS-REFERENCE TO RELATED APPLICATIONS

This application is a continuation of International Application No. PCT/US2021/056980, filed on Oct. 28, 2021, which claims the benefit of priority of U.S. Provisional Application Ser. No. 63/107,962 filed on Oct. 30, 2020, the content of which is relied upon and incorporated herein by reference in its entirety.

### FIELD

The disclosure is directed to female fiber optic connectors and cable assemblies comprising a female fiber optic connector having a weatherproofing collar disposed about an actuator and a portion of a main barrel along with methods of making the same. The disclosed female fiber optic connectors comprise a connection port suitable for receiving a complimentary male plug connector and securing or releasing the connector using an actuator such as a rocker latch arm.

### BACKGROUND

Optical fiber is increasingly being used for a variety of applications, including but not limited to broadband voice, video, and data transmission. As bandwidth demands increase optical fiber is migrating deeper into communication networks such as in fiber to the premises applications such as FTTx, 5G and the like. As optical fiber extends deeper into communication networks there exist a need for building more complex and flexible fiber optic networks using fiber optic connectors that are capable of making connections in a quick and easy manner.

Fiber optic connectors were developed for making plug and play optical connections at links or devices in the communication network such as terminals, cabinets, patch panels, and like. The fiber optic connectors allow the distribution of optical signals within an optical network and provide the flexibility of locating the devices in convenient locations for efficient network design and deployment and also deferring connectivity and the associated capital expense until needed in the communication network. Moreover, optical connector provide a convenient location for making moves, adds or changes in the communication network as needed. As the deployment of optical networks expands more optical connectors are needed for building complex communications networks especially in the outdoor environment (i.e., outdoor plant) as optical fiber is deployment deeper into the communications network for FTTx, 5G or other applications.

Conventional fiber optic connectors for the outdoor environment use threaded coupling nuts or components for retaining or releasing mating optical connectors. However, the use of threaded coupling nuts or components increase the size of the connectors or require additional space for finger access to turn the threaded coupling nuts or components. Consequently, terminals or other devices require the connectors to be larger due to the spacing required between adjacent connectors for finger access or the like. Moreover, it is not always intuitive to the user which side of the mated connection has the threaded component that rotates. Additionally, fiber optic connectors for the outdoor environment are required to withstand dirt, dust, debris and moisture that may be encountered in the outdoor space.

Consequently, there exists an unresolved need for fiber optic connector designs that provide quick and easy optical coupling that are also suitable for the outdoor environment. Moreover, the connector designs should allow manufacturing in a fast and flexible manner while still providing reliable optical performance.

### SUMMARY

The disclosure is directed to female fiber optic connectors having a connection port opening for receiving an external fiber optic plug or fiber optic connector for making an optical connection and retains the external plug connector using an actuator. The female fiber optic connector has an actuator that cooperates with the external plug connector. A weatherproofing collar is disposed rearward of the connection port opening and disposed about a portion of a main barrel and the actuator. The actuator of the female fiber optic connector may be biased to a normally-retain position for the external plug connector or not as desired. When the user wishes to release the external plug connector the actuator may be moved to a release position so the external plug connector may disengage the female fiber optic connector. By way of example, and not limitation, the actuator may be a rocker latch arm, but other actuators are possible according to the connector concepts disclosed such as a sliding button or rotating collar for releasing the external plug connector.

The disclosed female fiber optic connectors have a connection port for receiving a mating fiber optic plug along with a ferrule comprising one or more bores for receiving one or more optical fibers. The female fiber optic connector comprises a main barrel having a rear end and a front end with a passageway extending from the rear end to the front end, and the front end of the main barrel comprises a connection port opening. An actuator is capable of translating relative to the main barrel for releasing a mated fiber optic plug form the connection port opening. A weatherproofing collar may be disposed rearward of the connection port opening and disposed about a portion of the main barrel and the actuator for inhibiting the ingress of dirt, dust, debris or moisture into the female connector. By way of explanation and not limitation, the actuator may be a rocker latch arm that is attached to the main barrel, but other actuators are possible as discussed. In other embodiments, the main barrel may cooperate with an inner barrel if desired, but the female connector concepts disclosed may use a main barrel without an inner barrel if desired.

One aspect of the disclosure is directed to a female fiber optic connector having a connection port for receiving a mating fiber optic plug. The female connector comprises a ferrule having one or more bores for receiving one or more optical fibers, a main barrel, an actuator and a weatherproofing collar. The main barrel comprises a main barrel rear end and a main barrel front end with a main barrel passageway extending from the main barrel rear end to the main barrel front end, and the main barrel front end comprises a connection port opening. The actuator is capable of translating for releasing a mated fiber optic plug from the connection port opening. The weatherproofing collar is disposed rearward of the connection port opening and disposed about a portion of the main barrel and the actuator.

Another aspect of the disclosure is directed to a female fiber optic connector having a connection port for receiving a mating fiber optic plug. The female connector comprises a ferrule having one or more bores for receiving one or more optical fibers, a main barrel, an actuator configured as a rocker latch arm, one or more resilient members, and a weatherproofing collar. The main barrel comprises a main barrel rear end and a main barrel front end with a main barrel passageway extending from the main barrel rear end to the main barrel front end, and the main barrel front end comprises a connector port opening. The rocker latch arm comprises a pivot suitable for pivoting the rocker latch arm relative to the main barrel, and the one or more resilient members for biasing the rocker latch arm to a retain position. The weatherproofing collar is disposed rearward of the connection port opening and disposed about a portion of the main barrel and the rocker latch arm.

Another aspect of the disclosure is directed to a female fiber optic connector having a connection port for receiving a mating fiber optic plug. The female connector comprises a ferrule having one or more bores for receiving one or more optical fibers, an inner barrel, a main barrel, an actuator configured as a rocker latch arm, one or more resilient members, and a weatherproofing collar. The inner barrel comprises an inner barrel rear end and an inner barrel front end with an inner barrel passageway extending from the inner barrel rear end to the inner barrel front end. The inner barrel rear end comprises an inner barrel rear end opening sized for receiving the ferrule. The main barrel comprises a main barrel rear end and a main barrel front end with a main barrel passageway extending from the main barrel rear end to the main barrel front end. The main barrel rear end comprises a main barrel rear end opening sized for receiving the inner barrel, and the main barrel front end comprises a connector port opening. The rocker latch arm comprises a pivot suitable for pivoting the rocker latch arm relative to the main barrel, and comprises a latch and a rear end. The one or more resilient members are suitable for biasing the rocker latch arm to a retain position, where a portion of the one or more resilient members cooperates with the rear end of the rocker latch arm. The weatherproofing collar is disposed rearward of the connection port opening and disposed about a portion of the main barrel and the rocker latch arm.

A further aspect of the disclosure is directed to a female fiber optic connector having a connection port for receiving a mating fiber optic plug. The female connector comprises a ferrule having one or more bores for receiving one or more optical fibers, an inner barrel, a main barrel, an actuator configured as a rocker latch arm, one or more resilient members, a rear spring push, and a weatherproofing collar. The inner barrel comprises an inner barrel rear end and an inner barrel front end with an inner barrel passageway extending from the inner barrel rear end to the inner barrel front end. The inner barrel rear end comprises an inner barrel rear end opening sized for receiving the ferrule. The main barrel comprises a main barrel rear end and a main barrel front end with a main barrel passageway extending from the main barrel rear end to the main barrel front end. The main barrel rear end comprises a main barrel rear end opening sized for receiving the inner barrel, and the main barrel front end comprises a connector port opening. The rocker latch arm comprises a pivot suitable for pivoting the rocker latch arm relative to the main barrel, and comprises a latch and a biasing end. The one or more resilient members are suitable for biasing the rocker latch arm to a retain position, where a portion of the one or more resilient members cooperates with the biasing end of the rocker latch arm. The rear spring push is suitable for attaching to the main barrel. The weatherproofing collar is disposed rearward of the connection port opening and disposed about a portion of the main barrel and the rocker latch arm.

A still further aspect of the disclosure is directed to a female fiber optic connector having a connection port for receiving a mating fiber optic plug. The female connector comprises a ferrule having one or more bores for receiving one or more optical fibers, an inner barrel, a main barrel, an actuator configured as a rocker latch arm, one or more resilient members, a rear spring push, a spring, and a weatherproofing collar. The inner barrel comprises an inner barrel rear end and an inner barrel front end with an inner barrel passageway extending from the inner barrel rear end to the inner barrel front end. The inner barrel rear end comprises an inner barrel rear end opening sized for receiving the ferrule. The main barrel comprises a main barrel rear end and a main barrel front end with a main barrel passageway extending from the main barrel rear end to the main barrel front end. The main barrel rear end comprises a main barrel rear end opening sized for receiving the inner barrel, and the main barrel front end comprises a connector port opening. The rocker latch arm comprises a pivot suitable for pivoting the rocker latch arm relative to the main barrel, and comprises a latch and a rear end. The one or more resilient members are suitable for biasing the rocker latch arm to a retain position, where a portion of the one or more resilient members cooperates with the rear end of the rocker latch arm. The spring biases the inner barrel to a forward position in the main barrel. The weatherproofing collar is disposed rearward of the connection port opening and disposed about a portion of the main barrel and the rocker latch arm.

Yet another aspect of the disclosure is directed to a female fiber optic connector having a connection port for receiving a mating fiber optic plug. The female connector comprises a ferrule having one or more bores for receiving one or more optical fibers, an inner barrel, a main barrel, an actuator configured as a rocker latch arm, one or more resilient members, a rear spring push, a spring, a weatherproofing collar, and at least one cap disposed about an end of the weatherproofing collar. The inner barrel comprises an inner barrel rear end and an inner barrel front end with an inner barrel passageway extending from the inner barrel rear end to the inner barrel front end. The inner barrel rear end comprises an inner barrel rear end opening sized for receiving the ferrule. The main barrel comprises a main barrel rear end and a main barrel front end with a main barrel passageway extending from the main barrel rear end to the main barrel front end. The main barrel rear end comprises a main barrel rear end opening sized for receiving the inner barrel, and the main barrel front end comprises a connector port opening. The rocker latch arm comprises a pivot suitable for pivoting the rocker latch arm relative to the main barrel. The one or more resilient members are suitable for biasing the rocker latch arm to a retain position, where a portion of the one or more resilient members cooperates with a rear end of the rocker latch arm. The spring push is suitable for attaching to the main barrel, and the spring is for biasing the inner barrel to a forward position in the main barrel. The weatherproofing collar is disposed rearward of the connection port opening and disposed about a portion of the main barrel and the rocker latch arm.

Still another aspect of the disclosure is directed to a female fiber optic connector having a connection port for receiving a mating fiber optic plug. The female connector comprises a ferrule having one or more bores for receiving one or more optical fibers, an inner barrel, a main barrel, an actuator configured as a rocker latch arm, one or more resilient members, a rear spring push, a spring, a weatherproofing collar, and at least one cap disposed about an end of the weatherproofing collar. The inner barrel comprises an inner barrel rear end and an inner barrel front end with an inner barrel passageway extending from the inner barrel rear end to the inner barrel front end. The inner barrel rear end comprises an inner barrel rear end opening sized for receiving the ferrule. The main barrel comprises a main barrel rear end and a main barrel front end with a main barrel passageway extending from the main barrel rear end to the main barrel front end. The main barrel rear end comprises a main barrel rear end opening sized for receiving the inner barrel, and the main barrel front end comprises a connector port opening. The rocker latch arm comprises a pivot suitable for pivoting the rocker latch arm relative to the main barrel. The one or more resilient members are suitable for biasing the rocker latch arm to a retain position, and a portion of the one or more resilient members is disposed between the inner barrel and the rocker latch arm. The rear spring push is suitable for attaching to the main barrel, and the spring is for biasing the inner barrel to a forward position in the main barrel. The weatherproofing collar is disposed rearward of the connection port opening and disposed about a portion of the main barrel and the rocker latch arm.

Another aspect of the disclosure is directed to a female fiber optic connector having a connection port for receiving a mating fiber optic plug. The female connector comprises a ferrule having one or more bores for receiving one or more optical fibers, an inner barrel, a main barrel, an actuator configured as a rocker latch arm, one or more resilient members, a rear spring push comprising a cable strain relief portion, a spring, a weatherproofing collar. The inner barrel comprises an inner barrel rear end and an inner barrel front end with an inner barrel passageway extending from the inner barrel rear end to the inner barrel front end. The inner barrel rear end comprises an inner barrel rear end opening sized for receiving the ferrule. The main barrel comprises a main barrel rear end and a main barrel front end with a main barrel passageway extending from the main barrel rear end to the main barrel front end. The main barrel rear end comprises a main barrel rear end opening sized for receiving the inner barrel and the main barrel front end comprises a connector port opening. The rocker latch arm comprises a pivot suitable for pivoting the rocker latch arm relative to the main barrel. The one or more resilient members are suitable for biasing the rocker latch arm to a retain position, and a portion of the one or more resilient members is disposed between the inner barrel and the rocker latch arm. The rear spring push is suitable for attaching to the main barrel, and the spring is for biasing the inner barrel to a forward position in the main barrel. The weatherproofing collar is disposed rearward of the connection port opening and disposed about a portion of the main barrel and the rocker latch arm.

A further aspect of the disclosure is directed to a female fiber optic connector having a connection port for receiving a mating fiber optic plug. The female connector comprises a ferrule having one or more bores for receiving one or more optical fibers, an inner barrel, a main barrel, an actuator configured as a rocker latch arm, one or more resilient members, a rear spring push comprising a cable strain relief portion, a spring, and a weatherproofing collar. The inner barrel comprises an inner barrel rear end and an inner barrel front end with an inner barrel passageway extending from the inner barrel rear end to the inner barrel front end. The inner barrel rear end comprises an inner barrel rear end opening sized for receiving the ferrule. The main barrel comprises a main barrel rear end and a main barrel front end with a main barrel passageway extending from the main barrel rear end to the main barrel front end. The main barrel rear end comprises a main barrel rear end opening sized for receiving the inner barrel, and the main barrel front end comprises a connector port opening, and comprises a keying feature. The rocker latch arm comprises a pivot suitable for pivoting the rocker latch arm relative to the main barrel. The one or more resilient members are suitable for biasing the rocker latch arm to a retain position, and a portion of the one or more resilient members is disposed between the inner barrel and the rocker latch arm. The rear spring push is suitable for attaching to the main barrel, and the spring is for biasing the inner barrel to a forward position in the main barrel. The weatherproofing collar is disposed rearward of the connection port opening and disposed about a portion of the main barrel and the rocker latch arm.

Yet a further aspect of the disclosure is directed to a female fiber optic connector having a connection port for receiving a mating fiber optic plug. The female connector comprises a ferrule having one or more bores for receiving one or more optical fibers, an inner barrel, a main barrel, an actuator configured as a rocker latch arm, one or more resilient members, a rear spring push comprising a cable strain relief portion, a spring, and a weatherproofing collar. The inner barrel comprises an inner barrel rear end and an inner barrel front end with an inner barrel passageway extending from the inner barrel rear end to the inner barrel front end. The inner barrel rear end comprises an inner barrel rear end opening sized for receiving the ferrule. The main barrel comprises a main barrel rear end and a main barrel front end with a main barrel passageway extending from the main barrel rear end to the main barrel front end. The main barrel rear end comprises a main barrel rear end opening sized for receiving the inner barrel and the main barrel front end comprises a connector port opening, and comprises a keying feature configured as a male keying feature. The rocker latch arm comprises a pivot suitable for pivoting the rocker latch arm relative to the main barrel, and the rocker latch arm is disposed on the opposite side from the keying feature. The one or more resilient members are suitable for biasing the rocker latch arm to a retain position, and a portion of one or more resilient members is disposed between the inner barrel and the main barrel. The rear spring push is suitable for attaching to the main barrel, and the spring is for biasing the inner barrel to a forward position. The weatherproofing collar is disposed rearward of the connection port opening and disposed about a portion of the main barrel and the rocker latch arm.

Still a further aspect of the disclosure is directed to a female fiber optic connector having a connection port for receiving a mating fiber optic plug. The female connector comprises a ferrule having one or more bores for receiving one or more optical fibers, an inner barrel, a main barrel, an actuator configured as a rocker latch arm, one or more resilient members, a rear spring push comprising a cable strain relief portion, a spring, a weatherproofing collar, and one or more caps that cooperate with the weatherproofing collar. The inner barrel comprises an inner barrel rear end and an inner barrel front end with an inner barrel passageway extending from the inner barrel rear end to the inner barrel front end. The inner barrel rear end comprises an inner barrel rear end opening sized for receiving the ferrule. The main barrel comprises a main barrel rear end and a main barrel front end with a main barrel passageway extending from the main barrel rear end to the main barrel front end. The main barrel rear end comprises a main barrel rear end opening sized for receiving the inner barrel and the main barrel front end comprises a connector port opening, and comprises a keying feature configured as a male keying feature. The rocker latch arm comprises a pivot suitable for pivoting the rocker latch arm relative to the main barrel, and the rocker latch arm is disposed on the main barrel opposite from the keying feature. The one or more resilient members are suitable for biasing the rocker latch arm to a retain position, and the one or more resilient members is disposed between the inner barrel and the rocker latch arm. The spring push is suitable for attaching to the main barrel, and the spring is for biasing the inner barrel to a forward position in the main barrel. The weatherproofing collar is sized for being disposed about a portion of the main barrel, and one or more caps cooperate with the weatherproofing collar. The weatherproofing collar is disposed rearward of the connection port opening and disposed about a portion of the main barrel and the rocker latch arm.

Methods of making a fiber optic cable assembly having a female fiber optic connector comprising a connection port are also disclosed. The method comprises attaching one or more optical fibers of a fiber optic cable to a ferrule, inserting the ferrule into a passageway of an inner barrel. The inner barrel comprises an inner barrel rear end and an inner barrel front end with an inner barrel passageway extending from the inner barrel rear end to the inner barrel front end, where the inner barrel rear end comprises a rear end opening sized for receiving the ferrule. Placing the inner barrel within a main barrel, and the main barrel comprising a main barrel rear end and a main barrel front end with a main barrel passageway extending from the main barrel rear end to the main barrel front end. The main barrel rear end comprises a rear end opening sized for receiving the inner barrel and the main barrel front end comprises a connector port opening, and attaching an actuator to the main barrel. The weatherproofing collar is positioned rearward of the connection port opening about a portion of the main barrel and the actuator. The disclosed method may be directed to any suitable actuator as desired such as a rocker latch arm, sliding button or rotating collar for releasing the external plug connector.

Additional features and advantages will be set forth in the detailed description which follows, and in part will be readily apparent to those skilled in the art from that description or recognized by practicing the same as described herein, including the detailed description that follows, the claims, as well as the appended drawings.

It is to be understood that both the foregoing general description and the following detailed description present embodiments that are intended to provide an overview or framework for understanding the nature and character of the claims. The accompanying drawings are included to provide a further understanding of the disclosure, and are incorporated into and constitute a part of this specification. The drawings illustrate various embodiments and together with the description serve to explain the principles and operation.

### BRIEF DESCRIPTION OF THE FIGURES

FIG. 1 is a perspective view of an explanatory female fiber optic connector having a connection port with an actuator such as a rocker latch arm for retaining or releasing an external male plug connector that may be received in the connection port according to the concepts disclosed;

FIG. 2 is a perspective view of the female fiber optic connector of FIG. 1 shown with the dust plug removed from the connection port;

FIG. 3 depicts a perspective view of the female fiber optic connector of FIG. 2 showing how an external male plug connector may be aligned and inserted into the connection port opening of the female fiber optic connector for optical communication;

FIGS. 4A-4B are partial sectional views showing the rocker latch arm of the female fiber optic connector in the retain and release positions, respectively;

FIGS. 4C and 4D are partial views showing portions of a female fiber optic connector having a rocker latch arm biased by one or more resilient members;

FIGS. 5A-5C are partial views showing portions of another female fiber optic connector having a rocker latch arm biased by one or more resilient members;

FIGS. 6A and 6B are views showing portions of still another female fiber optic connector having a rocker latch arm biased by one or more resilient members;

FIG. 7A shows portions of yet another female fiber optic connector having a rocker latch arm that is biased by one or more resilient members;

FIG. 7B depicts another resilient member that may be used with the rocker latch arm of a female fiber optic connector;

FIG. 8 is an exploded view of an explanatory female fiber optic connector having an actuator;

FIG. 9 is a longitudinal cross-section view of the fiber optic cable assembly having the female fiber optic connector;

FIG. 10 is a longitudinal cross-sectional view of the fiber optic cable assembly having the female fiber optic connector with the dust plug aligned for insertion into the connector port of the female fiber optic connector;

FIG. 11 is a detailed cross-section view of the rocker latch arm of the female fiber optic connector translating as the dust plug or external male plug connector are inserted into the connection port;

FIG. 12 is a detailed cross-section view of the rocker latch arm of the female fiber optic connector biased to the normally-retain position after fully-inserting the dust plug or external male plug connector into the connection port;

FIG. 13 is a longitudinal cross-section view of the fiber optic cable assembly with the external male plug connector received and retained within the connection port of the female fiber optic connector;

FIG. 14 is a detailed sectional view of the rear portion of the female fiber optic connector depicting a weatherproofing collar having compression caps at opposing ends or not;

FIGS. 14A and 14B are detailed sectional views of the rear portion of a female fiber optic connector taken along orthogonal sections of the connector depicting another weatherproofing collar having a different end profile that may also use compression caps at opposing ends or not;

FIG. 15 is a rear perspective view of the inner barrel of the female fiber optic connector;

FIG. 16 is a sectional view of the inner barrel of the female fiber optic connector depicted in FIG. 15;

FIG. 17 is a front perspective view of the main barrel of the female fiber optic connector;

FIG. 18 is a sectional view of the main barrel of the female fiber optic connector depicted in FIG. 17;

FIGS. 19 and 20 are perspective views of the rocker latch arm of the female fiber optic connector of FIG. 8;

FIGS. 21 and 22 are perspective views of the resilient member for biasing the rocker latch arm of the female fiber optic connector of FIG. 8;

FIG. 23 is a perspective view of the rear spring push of the female fiber optic connector of FIG. 8;

FIG. 24 is a sectional view of the rear spring push of the female fiber optic connector of FIG. 8;

FIG. 25 is a perspective view of another inner barrel for the female fiber optic connector of FIG. 8;

FIGS. 26-40 show an explanatory method of making the female fiber optic connector of FIG. 8;

FIGS. 41-50 depict views and components of another explanatory female fiber optic connector having an actuator for releasing a mated plug connector similar to the explanatory female fiber optic connector of FIG. 8;

FIG. 51 depicts a sectional view of a female fiber optic connector that is terminated on a different fiber optic cable according to the concepts disclosed; and

FIGS. 52 and 53 show top and bottom perspective views of the external male plug connector suitable for mating with the female fiber optic connector as shown in FIG. 3.

### DETAILED DESCRIPTION

Reference will now be made in detail to the embodiments of the disclosure, examples of which are illustrated in the accompanying drawings. Whenever possible, like reference numbers will be used to refer to like components or parts.

The concepts disclosed are related to female fiber optic connectors (hereinafter “female connector(s)”) having a connection port along with fiber optic cable assemblies (hereinafter “cable assemblies” or “cable assembly”) using the female connectors and methods of making the same. As used herein, “connection port” means a cavity for receiving a fiber optic connector or external plug connector for making an optical connection. The female connectors disclosed comprise a connection port and an actuator such as a rocker latch arm or the like used for retaining (i.e., securing) or releasing an external male plug connector or dust plug received within the connection port. The female connectors disclosed are also ruggedized (i.e., suitable for outdoor environments) since they comprise a weatherproofing collar making the connector suitable for outdoor environments. The concepts disclosed provide a simple and reliable female connector suitable for outdoor environments that is quick and easy to assemble for terminating one or more optical fibers. The female connectors disclosed also allow for a quick and easy mating with a complimentary external plug connector (i.e., male plug connector that fits in the connection port) using an actuator such as the rocker latch arm.

On the other hand, conventional hardened connectors are mated using threads or bayonets on the connector. Threads or bayonets used on the conventional hardened connectors increase the size of the connectors or require spacing between adjacent connectors for suitable finger access. The female connectors disclosed advantageously have a relatively small diameter or form-factor compared with conventional connectors. By way of example, the female connectors may have a nominal maximum outer diameter of 20 millimeters or less (e.g., cross-sectional diameter taken perpendicular to the longitudinal female connector axis defined by a line passing thru the center of the mating face of the ferrule and extending rearward toward the rear of the female connector along the centerline). The female connectors and fiber optic cable assemblies disclosed may also provide a push-to-secure connection feature for mating with an external plug connector or dust plug if desired.

Alternatively, the female connectors may have an actuator that toggles between a retain and release position similar to a light switch if desired using the concepts disclosed. If the female connector has an actuator that toggles between a retain and release position, then a resilient member is not needed for biasing the actuator such as the rocker latch arm since it will positively retain and toggle between the respective retain and release positions.

The female connector concepts disclosed may be used with any suitable cables. Moreover, the female connector concepts are also scalable to any suitable count of optical fibers within the ferrule (e.g., 1-24 fibers or more) in a variety of arrangements or constructions. Further, the ferrule may have the bores for the optical fibers in one or more rows as desired.

The concepts disclosed herein are suitable for fiber optic networks such as for Fiber-to-the-location (FTTx), network densification, 5G applications, and are equally applicable to other optical applications as well including indoor, industrial, wireless, or other desired applications. Although, the concepts are shown with a robust and rugged female connector design useful for outdoor applications, the concepts may be used with non-rugged or indoor female connector designs if desired. Various designs, constructions, or features for the female connectors and cable assemblies are disclosed in more detail as discussed herein and may be modified or varied as desired.

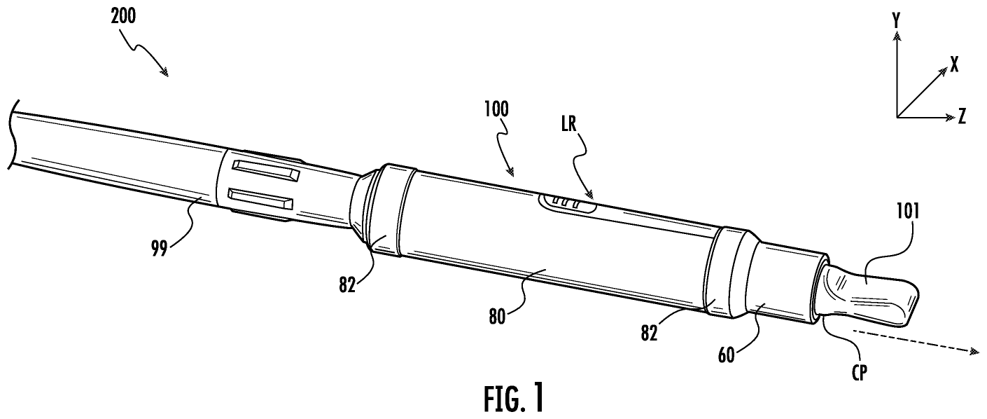

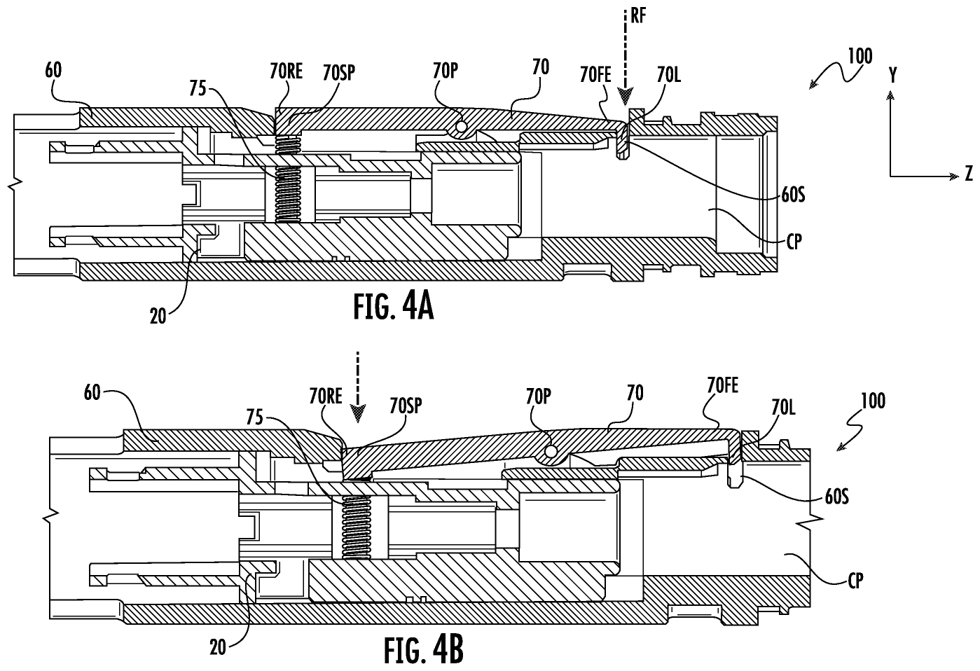

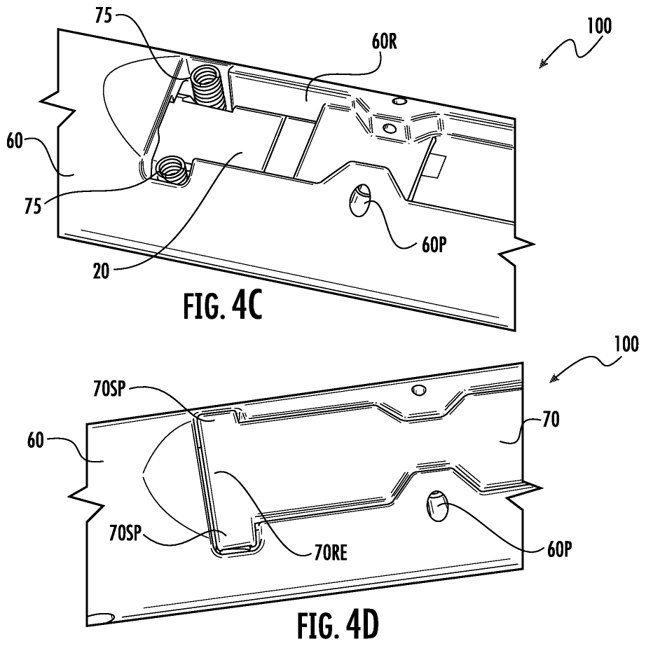

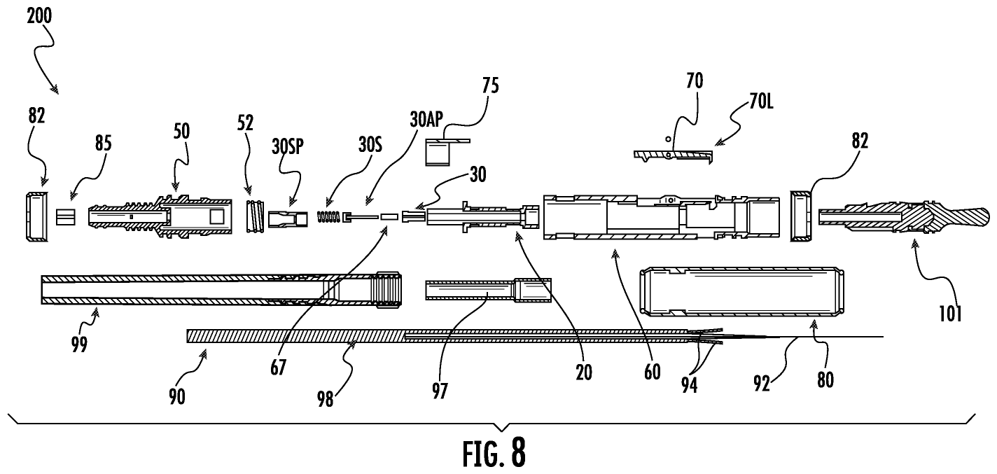

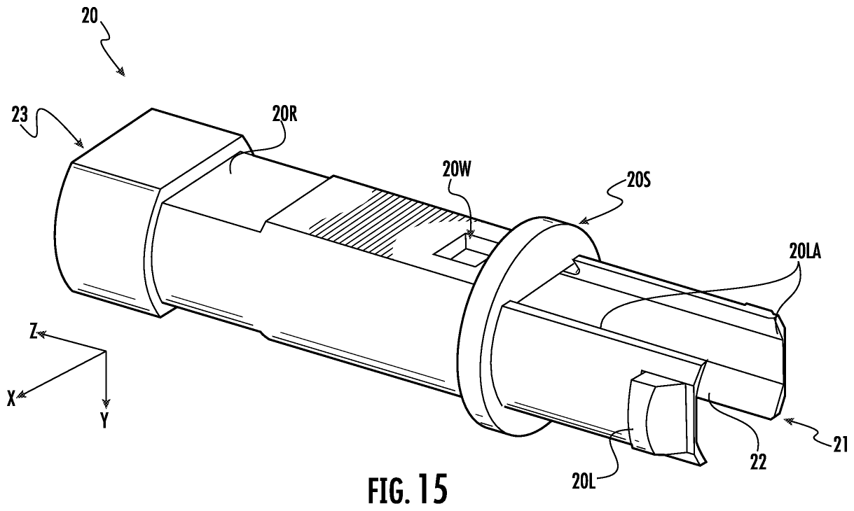

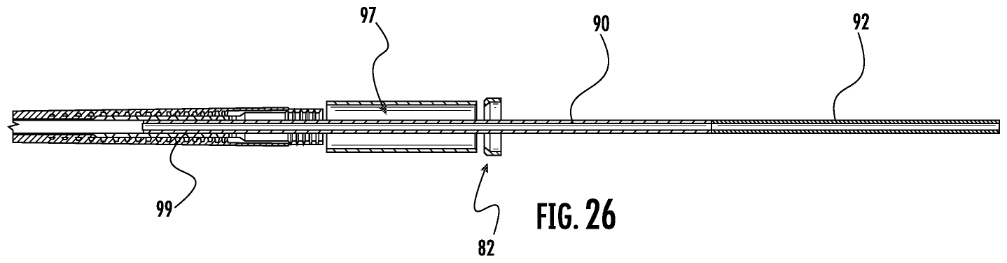

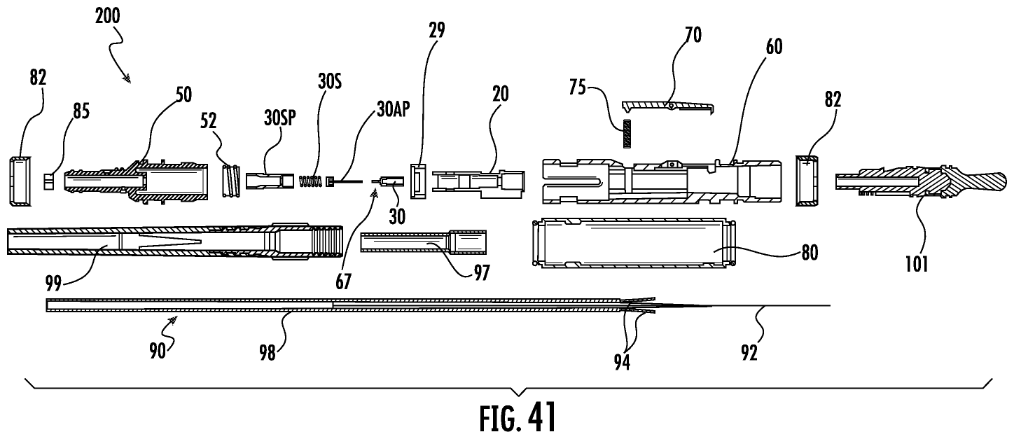

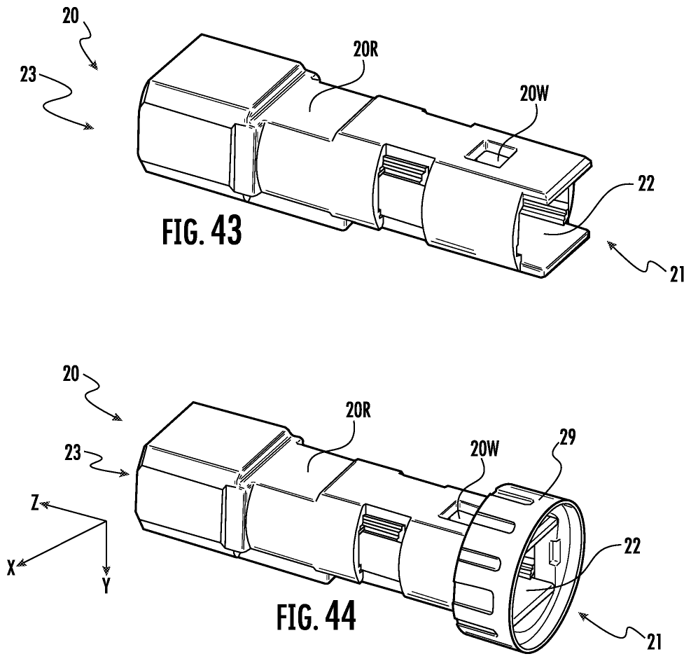

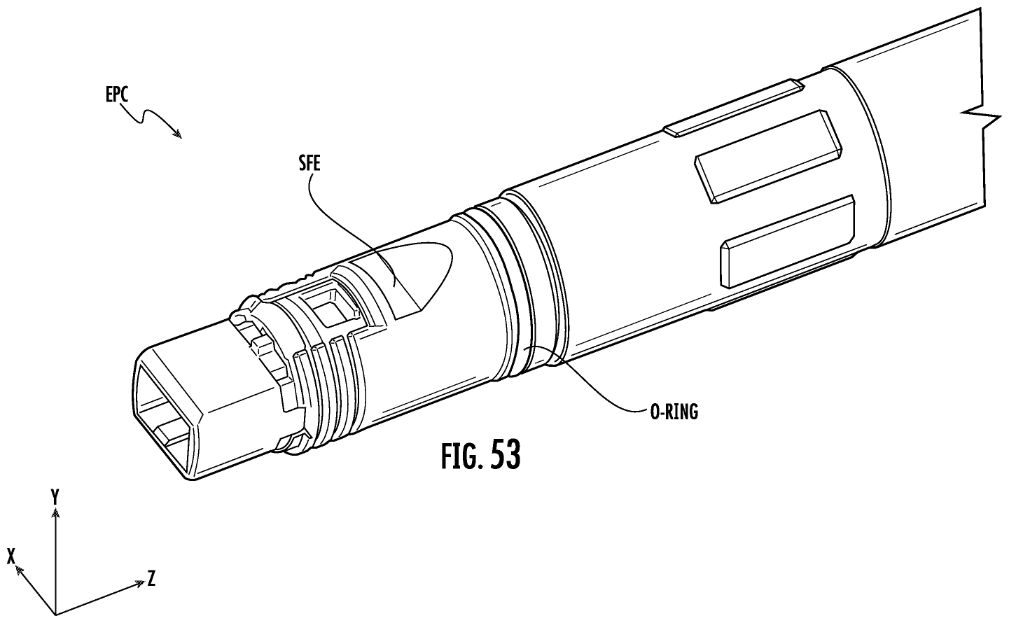

FIGS. 1-3 depict a cable assembly 200 having an explanatory female connector 100 comprising a connection port opening (CPO) according to the concepts disclosed. FIGS. 4a-7 depict alternative configurations that may be used with the female connectors 100 disclosed. FIGS. 8-14 show details of the construction for one explanatory cable assembly 200 having female connector 100, and FIGS. 15-25 are component views for the female connector 100. FIGS. 26-40 disclose the assembly steps for methods of making female connector 100 according to the concepts disclosed. FIGS. 41-51 disclose another variation of the female connector 100 similar to the female connector shown in FIGS. 8-14. FIGS. 52 and 53 are perspective views of an external plug connector (EPC) that may be mated with the female connector 100 for making an optical connection.

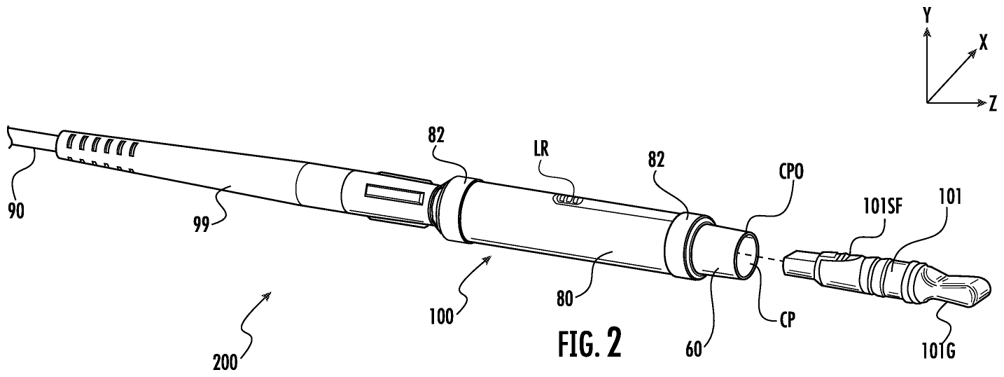

FIGS. 1-3 are perspective views of an explanatory female connector 100 terminating a fiber optic cable 90, thereby forming a cable assembly 200. Female connector 100 comprises a connection port (CP) for receiving a mating fiber optic plug (i.e., and external plug connector). FIG. 1 depicts female connector 100 with a dust plug 101 disposed in the connection port (CP) for keeping dirt, debris and the like out of the connection port (CP) of female connector 100, and FIG. 2 shows the female connector 100 with the dust plug 101 removed from the connection port (CP). Once dust plug 101 is removed from the connection port opening (CPO) access to the connection port (CP) is made available for inserting a complementary external plug connector (EPC) into the connection port (CP) for optical mating.

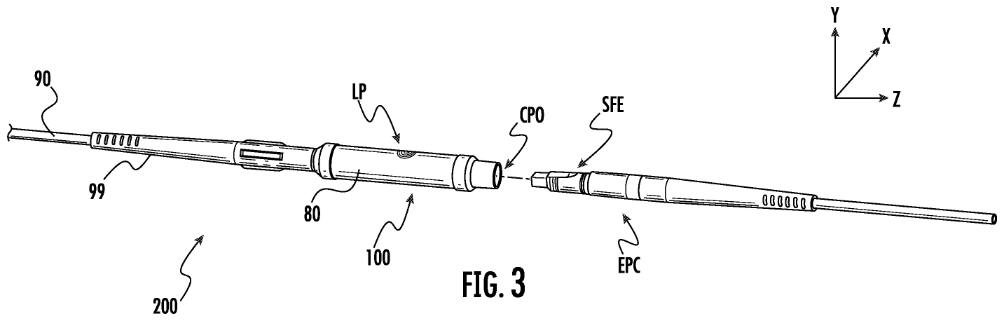

FIG. 3 shows an external plug connector (EPC) that may be aligned and inserted into the connection port opening (CPO) of the female connector 100 for optical mating in the connection port (CP) of the female connector 100. The connection port opening (CPO) leads to a cavity of the female connector 100 that forms the connection port (CP).

An actuator 70 such as a rocker latch arm of the female connector 100 cooperates with a securing feature 101SF of the dust plug 101 shown in FIG. 2 or the securing feature (SFE) of the external plug connector (EPC) shown in FIG. 3. For instance, the securing feature 101SF of the dust plug 101 or external plug connector (EPC) may be integrally formed in the dust plug or connector housing as a subtractive portion from a generally cylindrical geometry. Thus, no features such as a rotating coupling nut or bayonet that increases the size of the connector is required for mating.

The dust plug 101 or external plug connector (EPC) may be released from the connection port (CP) of the female connector 100 by pushing down on the latch release (LR) disposed on the female connector 100. Pushing the latch release (LR) of the actuator such as pushing down on the latch release for moving the rocker latch arm 70 from the retain position shown in FIG. 4A to the release position shown in FIG. 4B as represented by the vertical arrow. As depicted, pushing the latch release (LR) with sufficient force pivots the rocker latch arm 70 comprising a latch 70L to a release position as represented by the vertical arrow. Rocker latch arm 70 comprises a pivot 70P suitable for pivoting relative to a main barrel 70.

Actuator or rocker latch arm 70 may operate as a toggle between the release and retain positions like a light switch or the rocker latch arm 70 may be biased to a normally retain position by one or more resilient members 75.

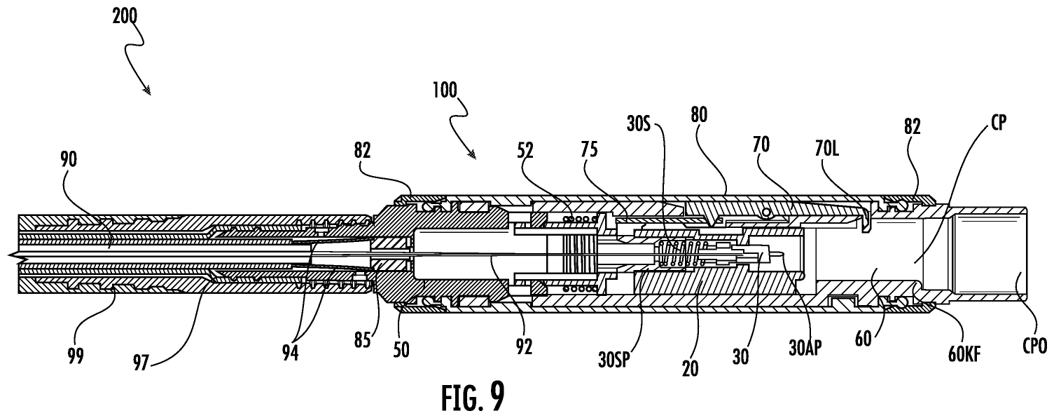

When the rocker latch arm 70 is biased to the normally-retain position, the external plug connector (EPC) may be secured in the connection port (CP) of the female connector 100 by pushing the external plug connector (EPC) into the connection port (CP). Specifically, the external plug connector (EPC) is rotationally aligned and pushed into the connection port (CP) of the female connector until a securing feature (SF) of the external plug connector (EPC) is secured by an actuator. Although, the explanatory concepts are depicted with an actuator configured as a rocker latch arm 70 of the female connector 100, other suitable actuators are possible such as a slider or rotating collar that may be a single component or use multiple components for cooperating with the external plug connector (EPC) as shown in FIG. 3 Specifically, as the external plug connector (EPC) is pushed into the connection port (CP) the profile of the external plug connector (EPC) pushes the latch 70L upward allowing insertion of the external plug connector (EPC) until the securing feature (SFE) of the external plug connector (EPC) reaches the latch 70L. Once the securing feature (SFE) of the external plug connector (EPC) reaches the latch 70L of the rocker latch arm 70, then the one or more resilient member 75 biasing the rocker latch arm 70 move to the latch 70L to the retain position and secure the external plug connector (EPC) in the connection port (CP) of the female connector 100 such as shown in FIG. 13. Likewise, the securing of the dust plug 101 with its securing feature 101SF occurs in a similar manner as shown in FIG. 9. Thus, mating between the female connector 100 and the external plug connector (EPC) or the dust plug 101 does not require turning a coupling nut or bayonet for making an optical connection.

Any suitable geometry or construction may be used for the actuator or rocker latch arm 70 of the female connector 100 disclosed herein. Also any suitable material may be used for the actuator or rocker latch arm 70 such as a polymer, metal or the like. Likewise, the one or more suitable resilient members 75 may be used for biasing the rocker latch arm 70 to a retain position. By way of example, the one or more resilient members 75 may be a coil spring, a leaf spring, a wave spring or a torsional spring as desired. FIGS. 4A-7 depict different constructions or arrangements for using one or more resilient members 75 for biasing the rocker latch arm 70 to a retain position. As depicted, rocker latch arm 70 comprises a portion that protrudes into the connection port (CP) of the female connector 100 when in the retain position.

FIGS. 4A and 4B depict rocker latch arm 70 comprises latch 70L on a forward end 70FE and a spring push 70SP on a rear end (or biasing end) 70RE. A portion of the one or more resilient members 75 cooperate with the rear end or biasing end 70RE of the rocker latch arm as shown. Rocker latch arm 70 has a pivot point 70P disposed between the forward end 70FE and the rear end 70RE. The pivot point 70P allows the rocker latch arm 70 to pivot relative to the female connector 70. As depicted, a main barrel 60 may comprise at least one slot 60S sized for receiving the latch 70L of the rocker latch arm 70.

FIGS. 4A and 4B show the rocker latch arm 70 being biased by one or more coil springs. When the rocker latch arm 70 is biased to the normally-retain position the latch 70L projects into the connection port (CP) as shown in FIG. 4A. When in the latch release 70LR of the rocker latch arm 70 is pushed downward with sufficient force the latch 70L moves to a position so it may release the device in the connection port such as no longer projecting into the connection port (CP) as shown in FIG. 4B. Select components of female connector 100 are not shown in FIGS. 4A and 4Bb for the sake of clarity.

FIG. 4C shows a portion of female connector 100 with the rocker latch arm removed for showing the arrangement of components among an inner barrel 20, main barrel 60 and one or more resilient members 75. As depicted, the inner barrel 20 is disposed within the main barrel 60. In this embodiment, inner barrel 20 has pockets (not numbered) for receiving a portion of the respective resilient members 75. Moreover, main barrel 60 may be shaped for cooperating with the inner barrel 20 for creating pockets for the respective resilient members 75 such as arcuate cutouts or the like depending on the type of resilient member used. As shown in this embodiment, a portion of the one or more resilient members 75 is disposed between the inner barrel 20 and the main barrel 60, but other arrangements are possible.

Main barrel 60 may also comprise a recess 60R sized for receiving a portion of the rocker latch arm 70 if desired. The recess 60R allows the rocker latch arm 70 to fit into main barrel 60 and providing a smaller footprint for the female connector 100. Main barrel 60 may also comprises a pivot mount 60P. Pivot mount 60P may have any suitable structure for attaching the rocker latch arm 70. For instance, the rocker latch arm 70 may have a snap-fit attachment or use a retainer 70R. Retainer 70R may be any suitable device such as a pin, a clip or the like for pivotally attaching the rocker latch arm 70 to the main barrel 60 as desired.

FIG. 4C depicts a plurality of resilient members 75 disposed within the female connector 100. Specifically, two resilient members 75 are depicted for biasing the actuator of the female connector. In this case, a first resilient member 75 is disposed on a first side of recess 60R and a second resilient member 75 is disposed on a second side of recess 60R, but other arrangements are possible for the resilient members to bias the actuator. The first and second resilient members 75 are coil springs for biasing the rocker latch arm 75 to the normally-retain position when the female connector 100 is assembled. As shown, the pockets for the two resilient members are disposed on opposites sides and disposed under the rearward wings at the rear end 70RE of the rocker latch arm 70. Of course, other types, counts or arrangements for the resilient member 75 are possible with the concepts for the female connectors 100 disclosed herein.

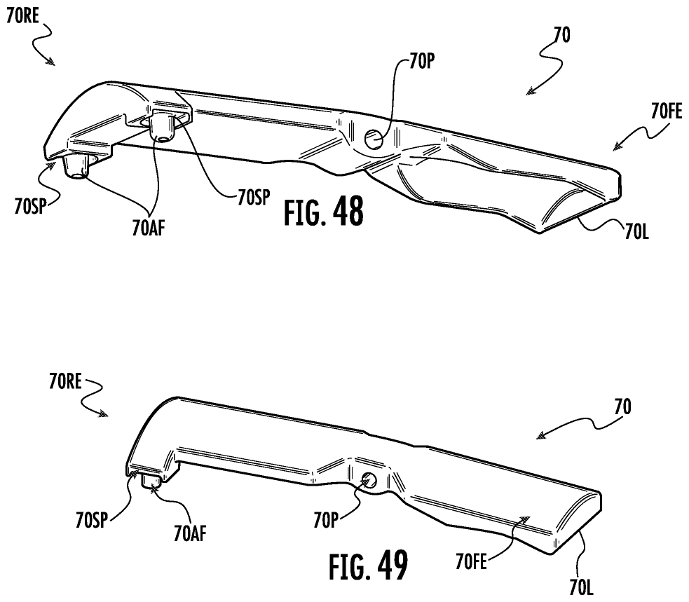

FIG. 4D shows the rocker latch arm 70 disposed within the recess 60R of main barrel 60 of the shown in FIG. 4C. One or more spring pushes 60P are disposed on a rear end 70RE of the rocker latch arm 70. This particular rocker latch arm 70 has a plurality of spring pushes 60 for cooperating with the resilient members 75. Specifically, this rocker latch arm has a first spring push 60P aligned over the first resilient member 75 and a second spring push 60P aligned over the second resilient member 75 at the rearward wings at the rear end 70RE. As depicted, the first and second spring pushes 60P are disposed on the outboard sides or wings of this rocker latch arm 70, but other configurations or arrangements are possible according to the concepts disclosed. Further details of this rocker latch arm 70 are shown in FIGS. 48 and 49.

Although the female connector concepts disclosed are shown with a main barrel and an inner barrel it may be possible to use the concepts without using an inner barrel and have the features on a main barrel. Using a main barrel without an inner barrel would be more complex to manufacture and/or assembly, but may be possible with the concepts disclosed and the concepts are not limited to designs requiring both an inner barrel and a main barrel as shown in the explanatory embodiments.

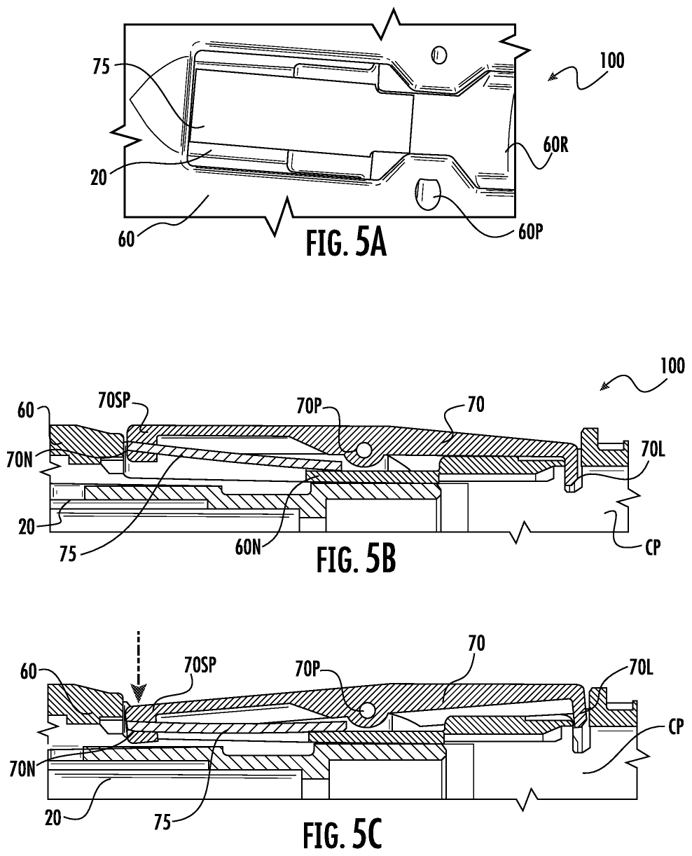

FIGS. 5A-5C depict another arrangement for explanatory female connectors 100 using the concepts disclosed herein. FIG. 5A shows a portion of a portion of female connector 100 with the rocker latch arm removed for showing the arrangement of components among the inner barrel 20, main barrel 60 and one or more resilient members 75. In this embodiment, a single resilient member 75 is used for biasing the rocker latch arm 70 to the normally-retain position. Resilient member 75 is configured as a leaf spring in this embodiment. As shown, resilient member 75 has a first end that fits within a notch 60N in the main barrel 60, and a second end disposed in a notch 70N disposed in the spring push 70SP of the rocker arm latch 70. Rocker arm latch 70 of this embodiment operates in a similar manner as discussed herein.

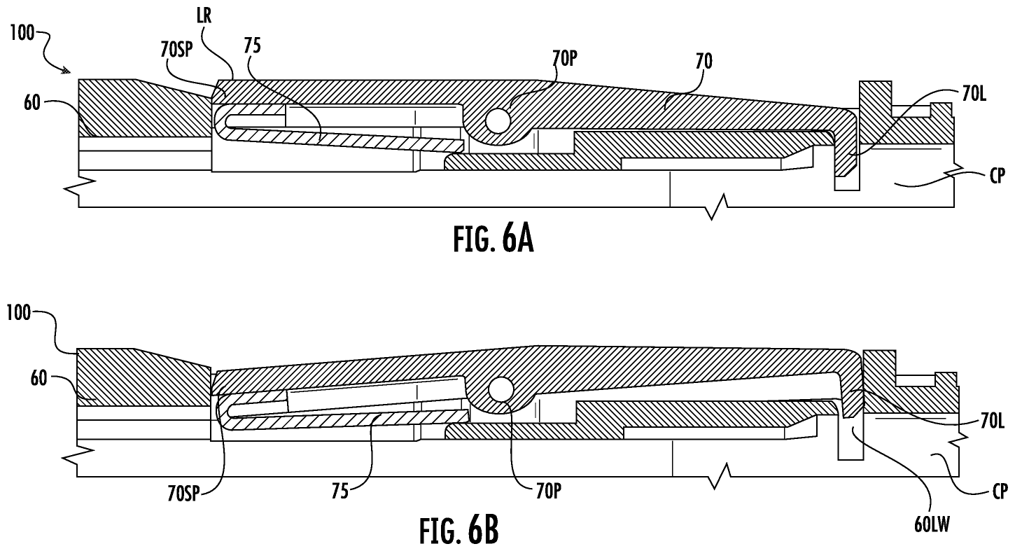

FIGS. 6A and 6B depict yet another arrangement for female connectors 100 using the concepts disclosed herein. FIG. 6A shows a single resilient member 75 is used for biasing the rocker latch arm 70 to the normally-retain position. Resilient member 75 is configured as a leaf spring in this embodiment. As shown, resilient member 75 has a first end that fits within a notch 60N in the main barrel 60, and a second end disposed in a notch 70N disposed in the spring push 70SP of the rocker arm latch 70. However, this embodiment of the resilient member 75 has a hairpin turn at the rear end for attaching to the spring push 70SP. Rocker arm latch 70 of this embodiment operates in a similar manner as discussed herein.

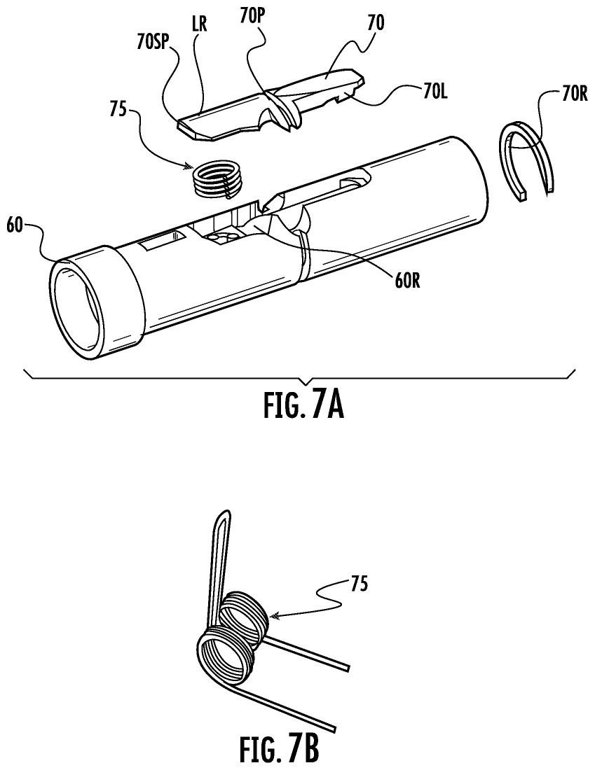

FIG. 7A depicts yet another arrangement for female connectors 100 using the concepts disclosed herein. FIG. 7A shows an partially exploded view of female connector 100 comprising rocker latch arm 70 that is biased by resilient member 75 to the normally-retain position. Although only a single resilient member 75 is shown a plurality of resilient members 75 may be concentrically disposed for biasing the spring push 70P of the rocker latch arm 70 to the normally-retain position. The resilient members 75 may have their restoring forces selected for tailoring the forces desired. In this embodiment, the rocker latch arm 70 is pivotally mounted to the main barrel 70 using a retainer 70R configured as a clip, but other retainers are possible for attaching the rocker latch arm 70 to the main barrel 60 such as a pin, screw, etc.

Still other types of resilient members may be used with the concepts disclosed. By way of example, FIG. 7B shows a resilient member 75 configured as a torsional spring that may be used with the concepts disclosed. Using one or more resilient members 75 configured as a torsional spring as shown may require a mounting for the coiled portion. However, it may also be possible for mounting the coiled portion at the pivot 70P, but this could increase the size of the female connector 100.

The one or more resilient members 75 provide a suitable downward retention force (RF) for maintaining the latch 70L of the rocker latch arm 70 in the retain position as depicted in FIG. 4A. Moreover, the restoring force provided by the one or more resilient members 75 at the spring push 70SP of the rocker latch arm 70 may have a multiplying factor due to the position of the pivot 70P relative to the length of the rocker latch arm rearward of the pivot to the spring push 70SP versus the length of the arm forward of the pivot 70P to the latch 70. In other words, the arm lengths for the rearward portion and the forward portion from the pivot may not be equal.

By way of explanation, the arm length from the pivot 70P to the spring push 70SP may have a normalized length of 1 unit, and the arm length from the pivot 70P to the latch 70P may have a normalized length of 1.1 units, thereby providing a multiplying factor to the restoring force (RF) provided by the one or more resilient members 75. The downward retention force (RF) for maintaining the latch 70L in the retain position may have any suitable value. By way of example, the downward retention force (RF) for maintaining the rocker latch arm 70 or latch 70L in the retain position is between 5 Newtons and 15 Newtons (N). In other embodiments, the downward retention force (RF) for maintaining the rocker latch arm 70 or latch 70L in the retain position is between 7N and 12N, but other ranges for the downward retention force (RF) are possible using the concepts disclosed.

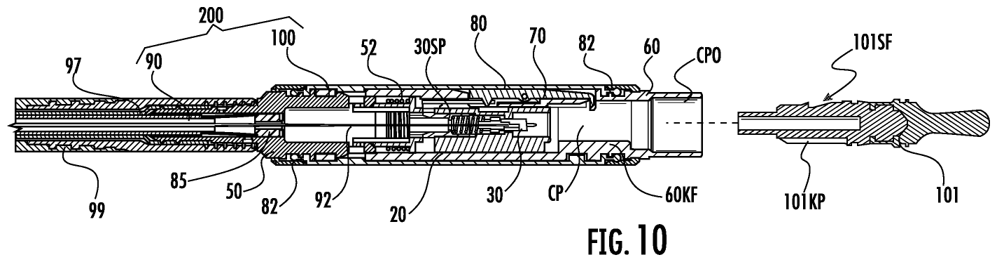

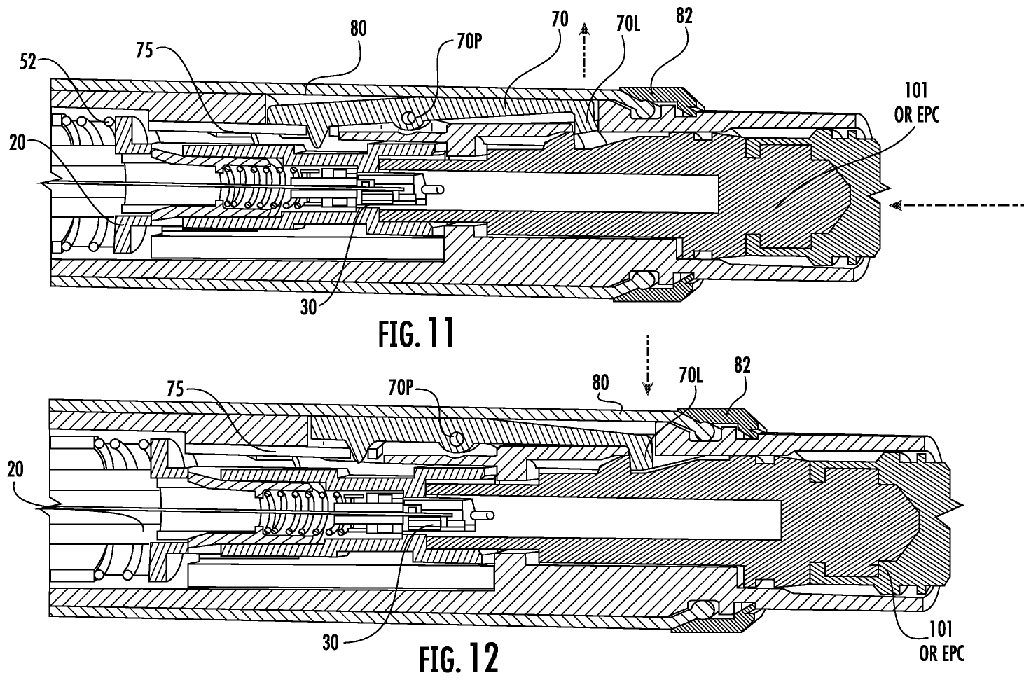

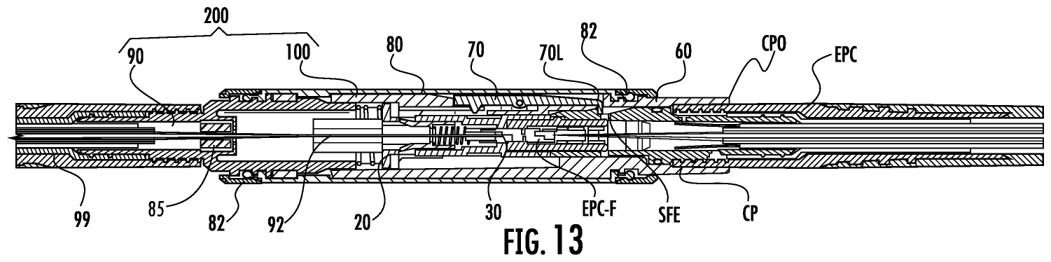

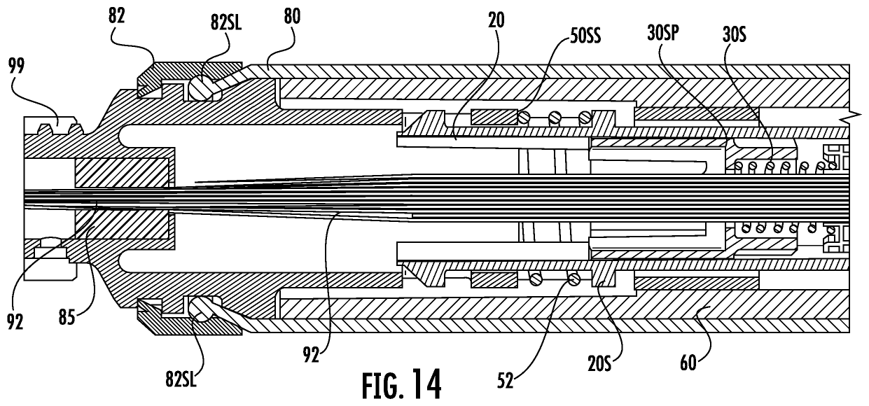

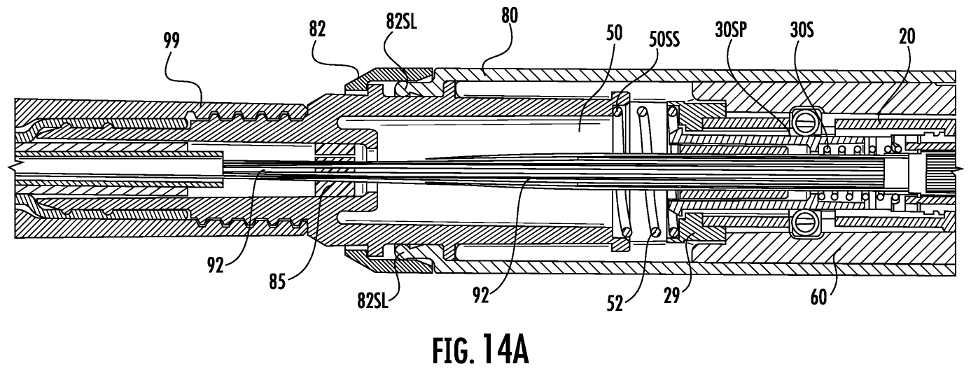

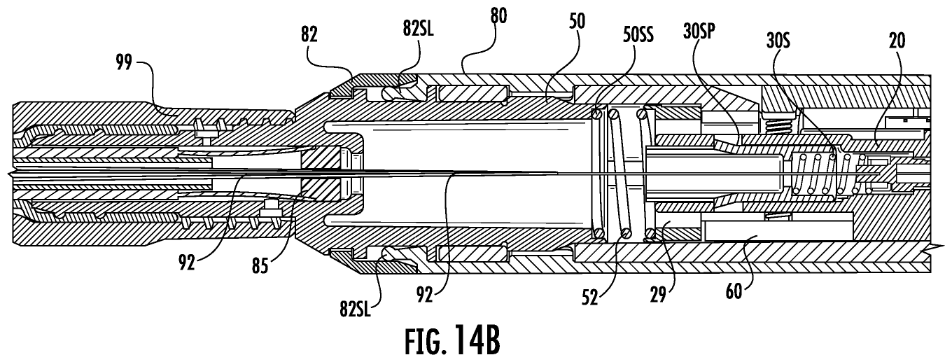

Still other arrangements are possible for biasing the rocker latch arm 75 to a normally-retain position. FIG. 8 is an exploded view of an explanatory female connector 100, and FIGS. 9 and 10 are longitudinal cross-sectional views of the fiber optic cable assembly 200 with the female connector 100. FIGS. 11 and 12 show details of the female connector 100 mating with a dust plug 101, which are similar to how the female connector 100 mates with the external plug connector (EPC), and FIG. 13 shows the female connector 100 mated with the external plug connector (EPC). FIG. 14 is a detailed partial sectional view of the rear portion of the female connector 100 having the weatherproofing collar 80, and FIGS. 14A and 14B show another variation of the weatherproofing collar 80 with a different end profile.

The specific construction of the inner barrel 20 or main barrel 70 will depend on the type of resilient member 75 and/or rocker latch arm 70 used for the female connector 100. Thus, the explanatory female connector 100 and components explained in further detail are shown as an example to explain the construction and assembly of the female connector 100 and not limitation for the concepts disclosed herein.

As depicted, the explanatory female connector 100 comprises a ferrule 30, inner barrel 20, main barrel 60 and rocker latch arm 70. The rocker latch arm 70 may toggle between the retain and release positions like a light switch, thereby maintaining a retain position or a release position until the rocker latch arm is moved to the other position.

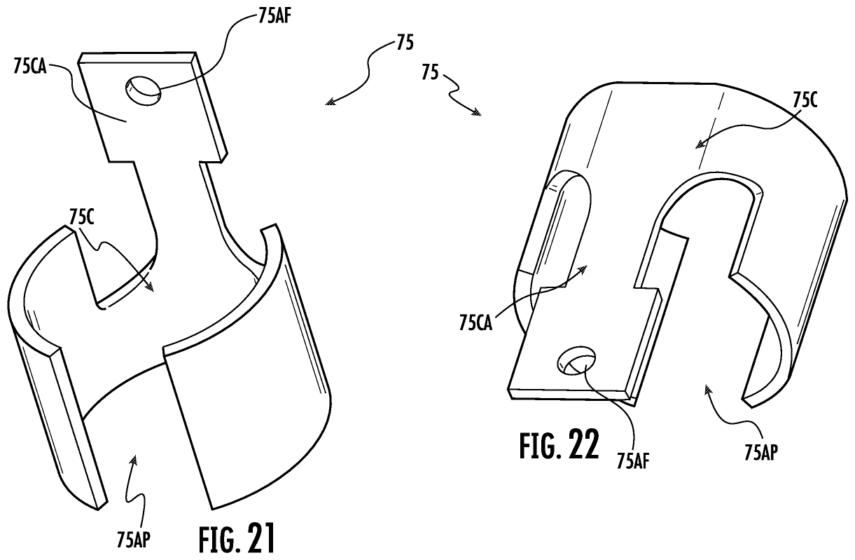

Alternatively, the female connector 100 may optionally comprise one or more resilient members 75 for biasing the rocker latch arm 70 to the normally-retain position as depicted. Like the other embodiments, a portion of the one or more resilient members 75 cooperates with rear end of the rocker latch arm 70 as shown. Again, rocker latch arm 70 comprises a pivot 70P suitable for pivoting relative to the main barrel 60 along with a latch 70L and a rear end 70RE, but other arrangements may be possible according to the concepts disclosed. As depicted in this embodiment, the resilient member 75 is configured as a leaf spring with a collar mount. This resilient member 75 shown in this embodiment is depicted in further detail in FIGS. 21 and 22.

FIG. 10 depicts dust plug 101 aligned with the connection port (CP) for the female connector 100 for insertion therein. Specifically, the keying portion 101KP of the dust plug 101 is aligned with the keying feature 60KP of the main barrel 60 as depicted. The keying feature 60KP may have any suitable shape such as a protrusion (i.e., key) or keyway. In this embodiment, the keying feature 60KP is configured as a male keying feature. The male keying feature protrudes into the connection port (CP) and inhibits the insertion of a non-compliant connector into the connector port (CP). The keying feature 60KP is clocked relative to the latch 70L of the rocker latch arm 70 in the desired orientation for mating with compliant devices.

By way of explanation and not limitation, the rocker latch arm 70 is disposed opposite from the keying feature 60KF on the main barrel (60). Consequently, the securing feature and keying portions on suitable mating devices will have a similar orientation to allow mating with the connection port. Consequently, the securing feature 101SF of the dust plug 101 is also disposed on the opposite side from the keying portion 101KP as shown in FIG. 10 (i.e., clocked about 180 degrees apart), thus the latch 70L of the rocker latch arm 70 is aligned with the securing feature 101SF of the dust plug when the keying portion 101KP is aligned with the keying feature 60KF of the main barrel 60.

Other clocking orientations between the keying feature 60KF and the rocker latch arm 70 of the female connector 100 are also possible according to the concepts disclosed instead of being disposed on the opposite side of the main barrel 60 (i.e., about 180 degree apart). By way of explanation, the clocking orientation between the keying feature 60KF and rocker latch arm 70 may be about 45, 90 or 135 degrees in either rotational direction as desired.

FIG. 11 shows the rocker latch arm 70 translating as the dust plug 101 is inserted into the connection port (CP) of female connector 100 as represented by the arrow pointing to the left. The external male plug connector (EPC) will also translate the rocker latch arm (70) as it is inserted into connection port (CP) of the female connector 100 in a similar manner, and it will not be illustrated for the sake of brevity. As depicted, as the dust plug 101 or external plug connector (EPC) is inserted into the connection port (CP) the housing pushes the latch 70L upward and depresses the resilient member 75 during the translation during insertion.

Once the dust plug 101 or external plug connector (EPC) is fully-inserted into the connection port (CP) so the latch 70L of the rocker latch arm 70 is aligned with the securing feature 101SF of the dust plug 101 or the securing feature (SFE) of the external plug connector (EPC), then the resilient member 75 biases the latch 70L to the normally-retain position as represented by the arrow shown in FIG. 12, thereby securing the dust plug 101 or external plug connector (EPC) in the connection port (CP). FIG. 13 shows the external male plug connector received and retained within the connection port (CP) of the female connector 100 so the optical fibers its ferrule (EPC-F) are in a mated state with the optical fibers 92 disposed in ferrule 30 for optical communication therewith. Additionally, the female connector 100 may be constructed so that the dust plug 101 or external plug connector (EPC) are slightly pushed outward when the rocker latch arm 70 is translated to the release position.

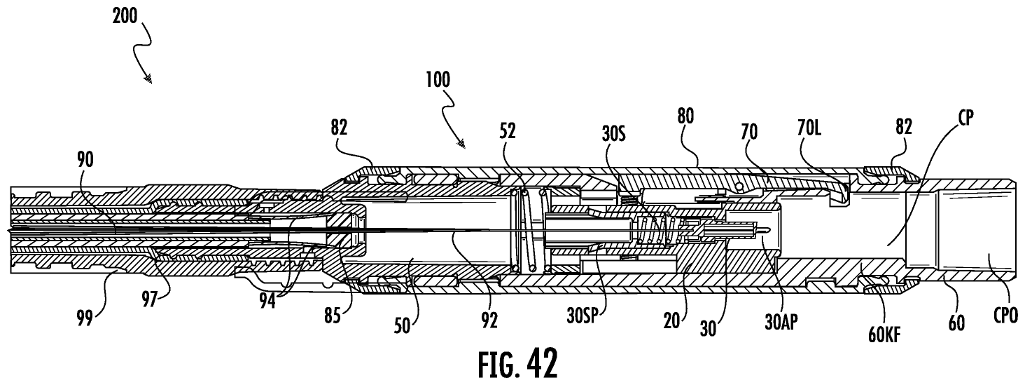

The securing feature 101SF dust plug 101 or securing feature (SFE) of the external plug connector (SFC) may have any suitable geometry for cooperating with the latch 70L of the female connector 100. By way of example, the securing feature 101SF of the dust plug 101 or securing feature (SFE) of the external plug connector (EPC) may be configured as a ramp with a ledge as the securing feature such as depicted in FIG. 10 or 42. The ramp and ledge allow for a push and retain feature for securing the dust plug 101 or external plug connector (EPC) in the connection port (CP) of the female connector 100. The securing feature may also comprise a flat portion disposed between the ramp and ledge if desired. Of course, other securing features or configurations are possible using the concepts disclosed herein.

The explanatory female connector 100 depicted may optionally comprise further components as desired. By way of explanation, female connector may further comprising a rear spring push 50. Rear spring push 50 may perform one or more functions for female connector 100. Rear spring push 50 be used for biasing inner barrel 20 to a forward position relative to main barrel 20. Specifically, rear spring push 50 traps a spring 52 between the rear spring push 50 and the inner barrel 20, thereby biasing the inner barrel 20 to a forward position relative to main barrel 60.

Rear spring push 50 may also comprise a cable strain relief portion. The cable strain relief portion may have one or more apertures leading to a cavity that may be filled with an adhesive or the like for securing fiber optic cable 90 to the female connector 100. Alternatively, a cable 90 may be strain-relieved to an outer portion of the rear spring push 50 depending on the cable construction. Other methods are also possible for securing fiber optic cable 90 to the female connector 100. Moreover, embodiments of female connector 100 need not have the spring push 50, and instead could incorporate features into the inner barrel 20 if desired, but this may result in a more complex part that is more difficult to manufacture.

As depicted, female connectors 100 comprise a weatherproofing collar 80 for providing a ruggedized female connector suitable for outdoor environments. As well-known to the skilled person, a ruggedized connector is suitable for outdoor plant applications and provides environmental protection that may be experienced in the outdoor environment. On the other hand, indoor optical connectors or optical connectors that are protected by an enclosure do not require the same type of protection from the environment as connectors used for outdoor applications.

Weatherproofing collar 80 is sized for being disposed about a portion of the main barrel 60 or female connector 100 as depicted in FIG. 9. As depicted, weatherproofing collar 80 covers the actuator such as the rocker latch arm 70 and inhibits dust, dirt, debris, moisture and the like from entering the female connector 100 at the interface between the rocker latch arm 70 and the main barrel 60 while allowing access to the connection port opening (CPO). Weatherproofing collar 80 may also comprise a marking indicia for indicating the location of the latch release of the rocker latch arm 70 to the user as depicted in FIG. 1. Marking indicia may be a raised portion to provide a tactile indication or marking on the weatherproofing collar 80 for the location of the latch release.

Weatherproofing collar 80 may be formed by any suitable material that provides environmental protection of the female connector 100 while still allowing the rocker latch arm 70 to translate between the retain position and the release position, and vice versa. Weatherproofing collar 80 may be formed from any suitable material for the desired environment. By way of example, weatherproofing collar 80 may be formed from an elastomeric material or other rubber-like material suitable for an outdoor environment. Generally speaking, using an elastomeric material for the weatherproofing collar 80 allows deformation of the weatherproofing collar 80 under load while being able to restore (or mostly restore) to its original shape when the load is removed. Moreover, elastomeric materials have a relatively high tear strength, are highly waterproof and resist corrosion, thereby making them a good candidate for the weatherproof collar 80. Consequently, the weatherproofing collar 80 may directly interface with the actuator of the female connector for moving from a normally-retain position to a release position during operation without tearing and then returning to its original shape while still providing suitable protection from dirt, debris, moisture and the like for weatherproofing female connector.

The weatherproofing collar 80 comprises a longitudinal cylinder having open ends so it may be slid over a portion of the female connector 100. One or more of the open ends of the weatherproofing collar 80 may be attached or sealed at the respective end to the female connector 100 using any suitable means if desired. The attaching or sealing of the one or more ends of the weatherproofing collar 80 may use a separate component or not. By way of example, the one or more ends of the weatherproofing collar 80 may be sealed using an adhesive, a crimp-band, a clip such as a circlip, a cap, heat-staking, ultra-sonic welding, or the like.

The weatherproofing collar 80 may also have other features for aiding in the attachment or sealing of one or more ends. For instance, the respective ends of weatherproofing collar 80 may comprise one or more ends with an integrally-formed sealing portion 80SL such as shown in FIGS. 14-14B.

By way of explanation, sealing portions 80SL may have enlarged lips about the perimeter at one or more ends, thereby providing material that may be compressed for creating a weatherproof seal at the ends of the weatherproofing collar 80. Likewise, portions of the female connector 100 such as a front portion of the main barrel 60 or the rear spring push 50 may have geometry for cooperating with the one or more ends of the weatherproofing collar 80. For instance, portions of the female connector 100 may have recesses or grooves for seating the sealing portion 80SL of the weatherproofing collar 80. In other variations, portions of the female connector 100 may have slightly out of round outer geometry where the sealing portions 80SL of the weatherproofing collar 80 engage. Other sealing portions 80SL for the weatherproofing collar 80 may include reservoirs or cavities for receiving an adhesive, material for sonic-welding or the like.

By way of one specific example, one or more caps 82 may be disposed at the interface between the ends of weatherproofing collar 80 and the female connector 100. One or more caps 82 cooperate with the weatherproofing collar 80 for attaching or sealing the respective ends of the same for inhibiting dirt, debris or moisture from. Caps 82 can compress the sealing portions 80SL of the weatherproofing collar 80 for inhibiting the ingress of dust, dirt, debris, moisture or the like at the one or more ends of the weatherproofing collar 80.

The geometry on respective portions of the female connector 100 may have geometry such as grooves, recesses or shoulders that cooperates with structure on the one or more caps 82 or other suitable component for aiding in the attachment of sealing such as by compression of a portion of one or more ends of the weatherproofing collar 80. In addition to the geometry on the female connector 100, the geometry of the one or more ends of the weatherproofing collar 80 may be tailored to cooperate with the cap 82 or other component for attaching or sealing the one or more ends. For instance, the one or more ends of the weatherproofing collar 80 may have rounded end shaped like a portion of an O-ring that may be compressed by cap 82. Likewise, the one or more ends of the weatherproof collar may have step-down shoulders and/or tapered end portions that fit into a groove or recess of the female connector 100 and cooperate with cap 82 or other like component. Cap 82 or other component may rotate for engaging the weatherproofing collar 80 or not depending on the design. In other embodiments, cap 82 or other component may push straight-on into position without rotating.

FIGS. 14A and 14B show partial sectional views of the rear portion of the female connector 100 taken along orthogonal sections depicting another weatherproofing collar 80 having a different end profile from the weatherproofing collar of FIG. 14. As shown, the weatherproofing collar 80 of FIGS. 14A and 14B comprises an end profile having a stepped-down shoulder that fits into the groove 60G of the main barrel 60. This embodiment allows a robust sealing interface between the weatherproofing collar 80 and the main barrel and may be used with or without a cap 82 as desired. Of course, still other methods or structures are possible for attaching or sealing the weatherproofing collar 80 to female connector 100.

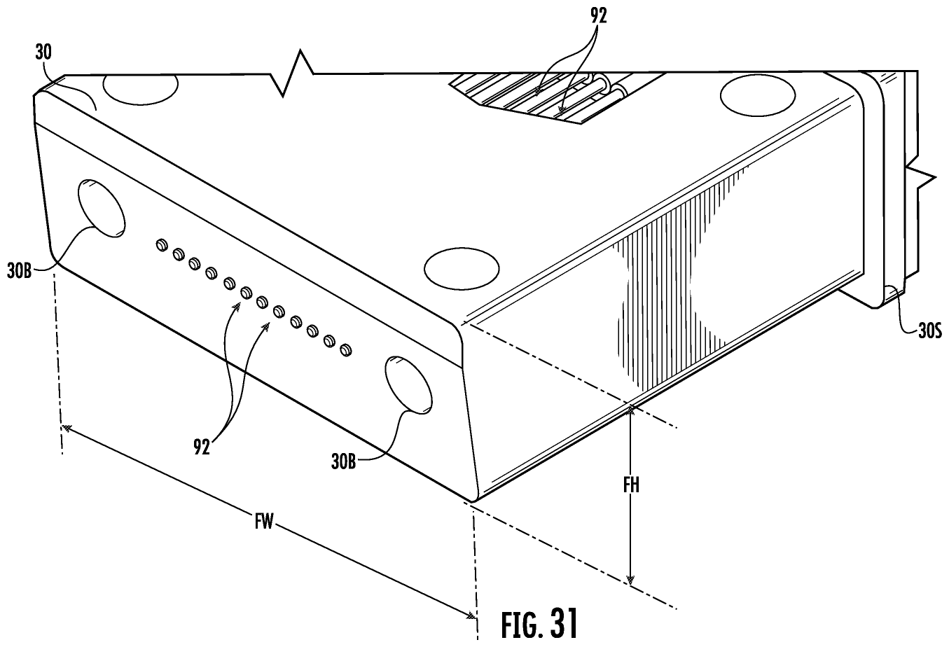

Ferrule 30 comprises one or more bores 32 as best shown in FIG. 31 for attaching one or more optical fibers 92 as known in the art. By way of example, ferrule 30 may be a MT, MPO ferrule, but other suitable ferrule are possible using the disclosed concepts such as one or more single fiber ferrules. When assembled, ferrule 30 is disposed within inner barrel 20.

Ferrule 30 may also be associated with other components as desired and may depend on the type of ferrule used by the female connector. In this embodiment, ferrule 30 is an MT or MTP® ferrule that may use alignment pins 30AP for mating with a complementary ferrule of the external plug connector (EPC) such as depicted in FIG. 13. Alignment pins 30AP are sized for cooperating with alignment bores 30B of ferrule 30 and provide precision alignment between mating ferrules of the female connector 100 and the external plug connector (EPC). Other ferrules may not require alignment pins 30AP or the alignment pins may be disposed on the external plug connector (EPC) if desired.

Ferrule 30 may be associated with other components as well such as a spring 30S. As shown, the ferrule 30 may be biased to a forward position within inner barrel 20 using spring 30S. Spring 30S may be captured within the inner barrel 20 using a spring push 30SP.

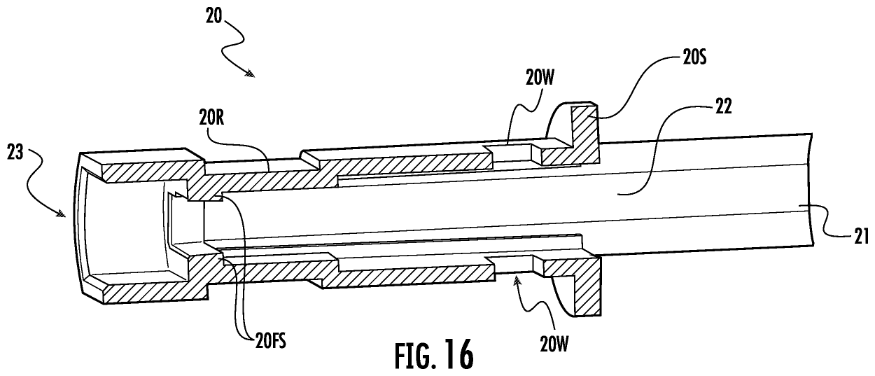

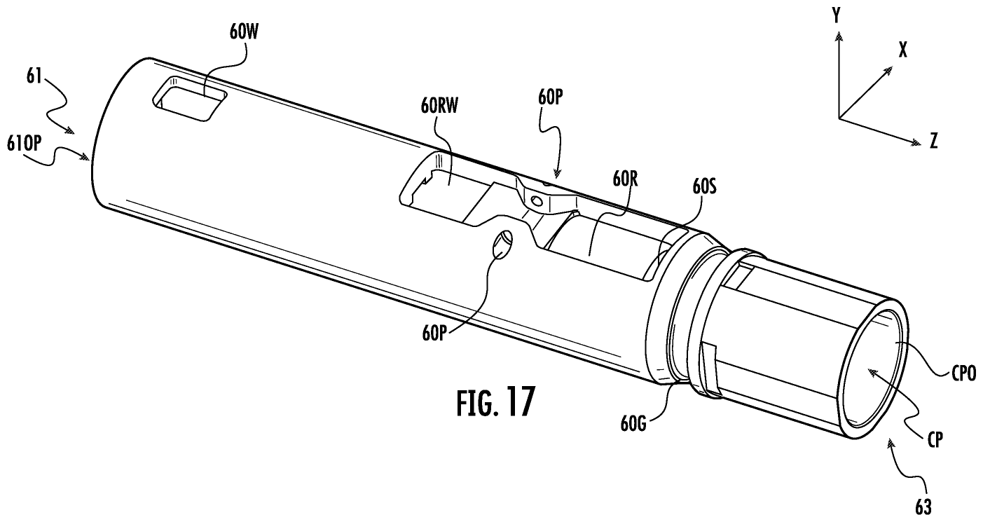

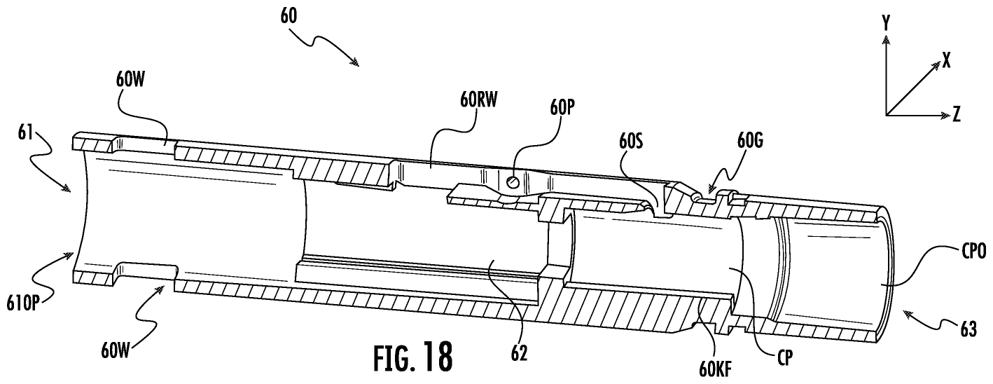

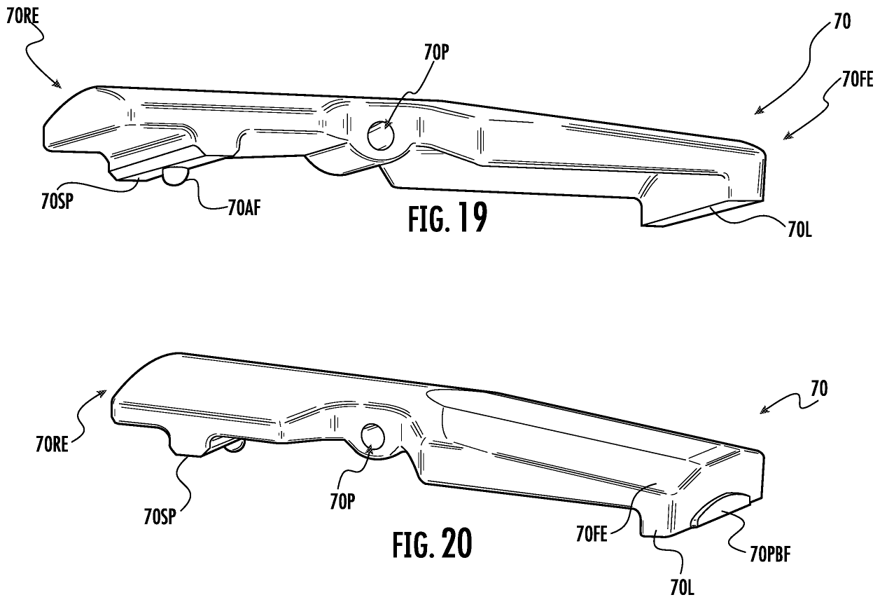

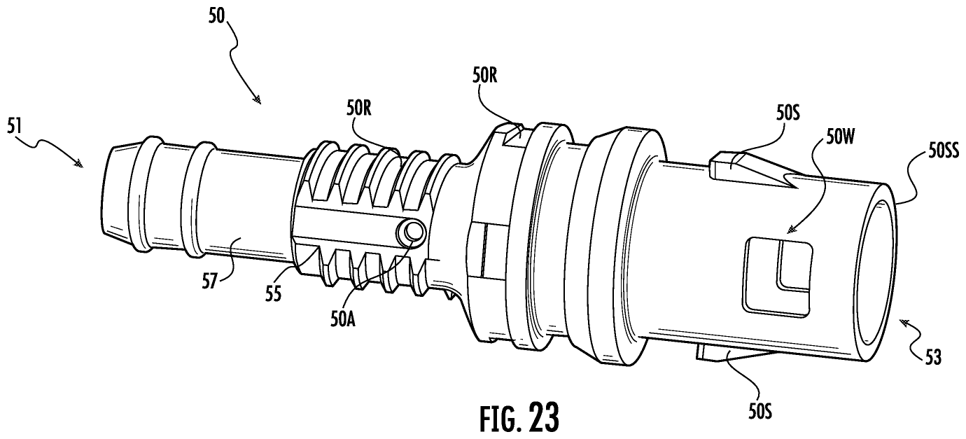

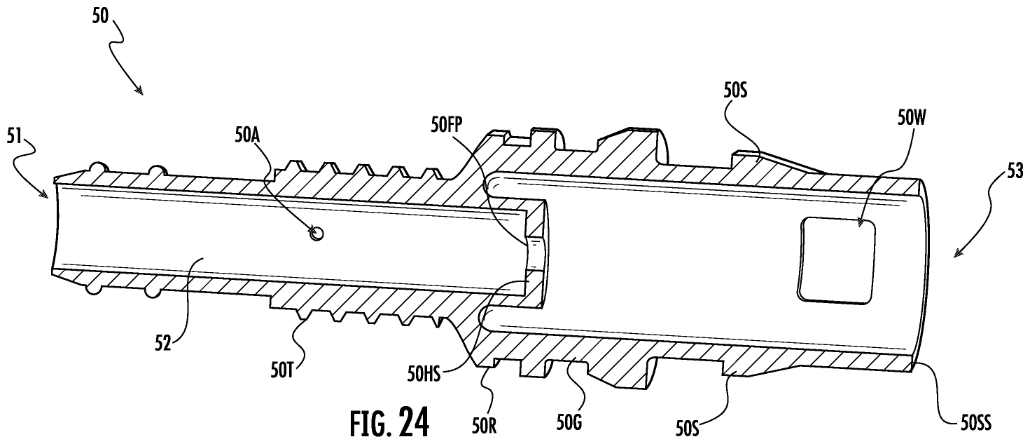

Detailed views of components for the explanatory female connector 100 of FIG. 8 are shown in FIGS. 15-24, and FIG. 25 depicts an alternative inner barrel 20 as a further example of how components may different depending of the design. Specifically, FIGS. 15 and 16 show detailed views of inner barrel 20, FIGS. 17 and 18 show detailed views of main barrel 60, FIGS. 19 and 20 show detailed views of rocker latch arm 70, and FIGS. 21 and 22 show detailed views of the resilient member 75, and FIGS. 23 and 24 show detailed views of the spring push 50. Another explanatory female connector 100 similar to the female connector 100 of FIG. 8 is shown in FIGS. 41-52. The features and components for the explanatory female connectors will now be explained in further detail.

As best depicted in FIGS. 15 and 16, inner barrel 20 comprises an inner barrel rear end 21 and an inner barrel front end 23 with an inner barrel passageway 22 extending from the inner barrel rear end 21 to the inner barrel front end 23. The inner barrel rear end 21 of inner barrel 20 comprises an inner barrel rear end opening 210 sized for receiving the ferrule 30.

To assemble the ferrule 30 within the inner barrel 20 of female connector 100 the optical fibers 92 of fiber optic cable 90 are attached to ferrule 30, and then the alignment pins 30AP may be attached to the ferrule if used. The ferrule 30 with the alignment pins 30AP may be inserted into the inner barrel 20 from the inner barrel rear end opening 210 and the spring 30S and a ferrule spring push 30SP are slid forward so the spring push 30SP is attached to the inner barrel 20 for biasing the ferrule 30 to a forward position within the inner barrel 20. Spring push 50 may be attached to inner barrel in any suitable manner.

As best shown in FIG. 16, inner barrel comprises a ferrule stop 20FS within the longitudinal passageway 22 acting as a forward stop for the ferrule 30. Spring 30S biases the ferrule 30 forward to the ferrule stop 20FS. Ferrule stop 20FS limits travel of the ferrule 30 to the front of inner barrel 20, but the ferrule 30 is allowed to move rearward during mating as needed subject to the restoring forward-force of the spring 30S. Spring 30S aids in maintaining physical contact between optical fibers 92 disposed in the ferrule 30 when the female connector is in a mated state for optical connection.

Ferrule stop 20FS also defines a window (not numbered) for coarse alignment of the ferrule 30 within the inner barrel 20. In this embodiment, the ferrule window is a rectangular opening sized for an MT ferrule, but other shapes or sized may be used depending on the type of ferrule used in the female connector 100. Specifically, the window adjacent to ferrule stop 20FS is sized for a ferrule width FW and a ferrule height FH as shown in FIG. 31, while not allowing a ferrule shoulder 30S to pass thru the window of the inner barrel 20.

The disclosed female connector 100 may allow limited movement or “float” of the ferrule within the connector in the unmated state for allowing limited movement of the ferrule during mating with a complimentary device. The limited movement or “float” of the ferrule during mating allows two degrees of freedom of movement (X- and Y-axis) of the ferrule during mating. By way of example, the ferrule is allowed limited movement between about 100-400 microns of movement in the two degrees of freedom for allowing the ferrule to “float” in the unmated state, but other ranges of limited movement are possible for the movement of the ferrule within the connector. For instance, the ferrule may allowed limited movement between about 150-350 microns in the two degrees of freedom (X and Y directions) for allowing the ferrule to “float” within the connector in the unmated state, or the ferrule may allowed limited movement between about 200-300 microns of movement in the two degrees of freedom, thereby allowing the ferrule to “float” within the connector in the unmated state.

Inner barrel 20 may also include one or more windows 20W or other features for cooperating with retaining features such as latches or protrusions on the spring push 30SP for retaining the ferrule 30 and spring 30S within the inner barrel 20. Windows 20W are sized for receiving latches or protrusions on the ferrule spring push 30SP, thereby providing a snap-fit construction, but other structures are possible.

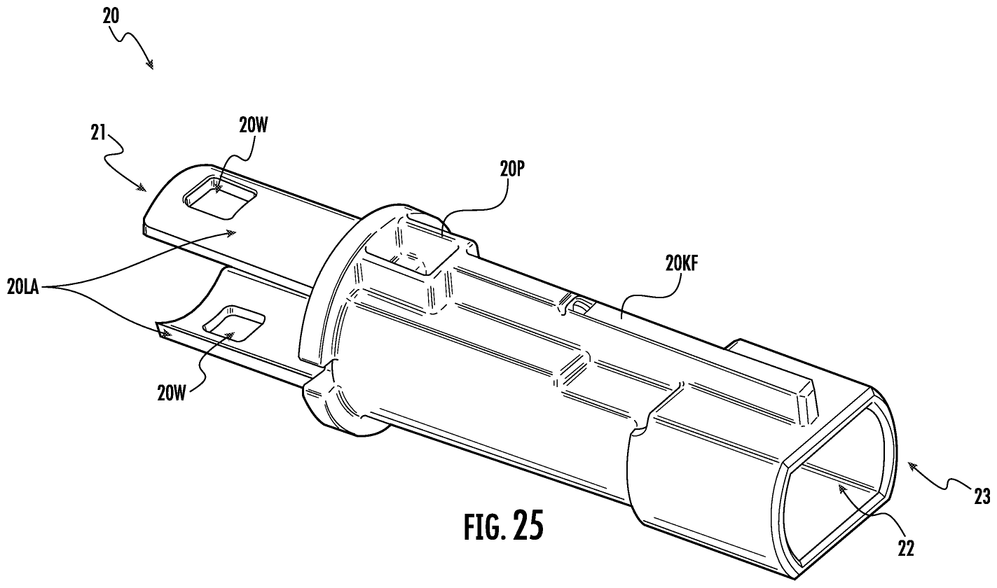

Inner barrel 20 may also comprise one or more retention features for attaching spring push thereto. For instance, retention features of inner barrel may be latch arms 20LA comprising latches 20L. Latch arms 20LA allow the spring push 50 to attach to the inner barrel 20 in a quick and reliable manner by deflecting inward until the proper position is reached at which point the latch arm spring outward. Specifically, the latches 20L on latch arms 20LA may snap-fit into retention features on the spring push 50 such as windows or recesses 50W. However, other structures or arrangements are possible for assembling the components. The inner barrel 20 depicted in FIGS. 15 and 16 also has a recess 20R for allowing deflection of a portion of resilient member 75. In this embodiment, inner barrel 20 may fit into the main barrel in either orientation (i.e., up or down) since the part is symmetrical; however, the inner barrel 20 may be constructed so that it only fits into the main barrel 60 in one orientation such as shown in FIG. 25.

The front portion of passageway 22 of inner barrel 20 may also comprise a mating connector housing alignment feature (not numbered). Mating connector housing alignment feature is sized and shaped for receiving a front portion of the housing of the external plug connector (EPC) intended to be received within the connection port (CP) of female connector 100 as shown in FIG. 13, which also aids in alignment of ferrules so that alignment pins 30AP may properly align and engage during mating. Inner barrel 20 may also include a shoulder 20S. Shoulder 20S is sized for allowing spring 52 to seat to the shoulder 20S, thereby biasing inner barrel 20 a forward position in the main barrel 60. Shoulder 20S also cooperates with the passageway 62 of main barrel 60 for properly aligning the inner barrel 20 within the main barrel 60.

Spring push 50 comprises a passageway 52 from a spring push front end 53 to a spring push rear end 51. A spring seat 50SS is disposed at the front end 53 and acts a rear stop for trapping the spring 52 for biasing the inner barrel 20 forward when assembled as best shown in FIG. 14. Spring push 50 also comprises one or more retention features 505 such as snaps for engaging with the one or more windows 60W of the main barrel 60.

As best shown in FIGS. 17 and 18, main barrel 60 comprises a main barrel rear end 61 and a main barrel front end 63 with a main barrel passageway 62 extending from the main barrel rear end 61 to the main barrel front end 63. The main barrel rear end 61 comprises a main barrel rear end opening 610 sized for receiving the inner barrel 20, and the main barrel front end 63 comprises a connection port opening (CPO). The connector port opening leads to a connection port (CP) that forms a cavity for receiving a portion of the external plug connector (EPC) as shown in FIG. 13.

Main barrel 60 may also comprise a recess 60R shaped for receiving a portion of the rocker latch arm 70. The shape and size of the recess may depend on the specific rocker latch arm 70 used. Main barrel 60 may also comprise at least one slot 60S sized for receiving a latch 70L of the rocker latch arm 70. Slot 60S allow a portion of the rocker latch arm 70 to protrude into the connection port (CP) when in the retain position. As depicted in this embodiment, the slot 60s is disposed in the recess 60R.

Main barrel 60 may also include a pivot 60P formed therein. The pivot 60R allows attachment of the rocker latch arm 70 thereto in a pivoting manner. The pivot may allow direct attachment of the rocker latch arm or attachment of retainer 70R for attachment of the rocker latch arm 70 as desired. The main barrel 70 may also include a recess window 60RW rearward of the pivot 60P for allowing the rear end 70RE of the rocker latch arm to engage with the one or more resilient members 75. Main barrel 60 may also comprise one or more retention features for attachment. For instance, the main barrel 60 may comprise one or more windows 60W for attaching the main barrel 60 to the spring push 50. However, other structures are possible for securing the main barrel 60 such as a recess or latch as desired.

Main barrel 60 has a generally round shape or cylindrical sleeve with one or more features integrally formed in the primitive geometry of the cylindrical sleeve as discussed and shown. For instance, main barrel may also comprise a groove 60G. Groove 60G and/or other structure that may allow for the compression of the end of the weatherproofing collar 80 using cap 82 at the front end. Likewise, the spring push 50 may have a groove 50G and/or other structure that may allow for the compression of the end of the weatherproofing collar 80 using cap 82 at the rear end. By way of explanation, a chamfered edge may be adjacent to the groove 50G,80G to inhibit sharp bends of the weatherproof collar and one or more ridge may be on the other side of the groove 50G,80G to allow seating of the cap 82 to the female connector 100.

Female connector 100 may include an interface between the inner barrel 20 and main barrel 60 with one or more clocking features for rotational alignment during assembly. While the complimentary alignment feature on inner barrel 20 may be a protrusion such as male key and a keyway on the main barrel 60. However, the alignment features could be reversed with suitable geometry. Moreover, inner barrel 20 and main barrel 60 do not require an alignment feature; however, the use of the alignment features allow assembly of the inner barrel 20 and main barrel 60 in only a single orientation if desired.

Main barrel 60 may include still other features if desired. For instance, main barrel 60 may further comprise a suitable keying feature. By way of example, main barrel 20 comprises a keying feature (60KF). Keying feature 60KF is disposed within the connection port (CP). One arrangement may have the keying feature 60KF integrally formed in the main barrel 60. As an example, keying feature 60KF may be a male keying feature. In this case, the keying feature 60KF protrudes from an inner wall of the main barrel 60 for cooperating with the keying portion 101KP on the dust plug 101 as shown in FIG. 10 or the keying portion KP on the external plug connector (EPC) such as shown in FIG. 53. Keying feature 60KF of main barrel may have a specific orientation relative to the rocker latch arm 70. For instance, the rocker latch arm 70 may be disposed on the opposite side) from the keying feature 60KP (i.e., about 180 degrees apart) on the main barrel 60, but other orientations are possible as well.

Main barrel 60 or inner barrel 20 may be formed from any suitable material(s) such as a polymer, metal, composite, etc. The materials selected may depend on the construction or intended environment. For instance, if the female connector is intended for outdoor environments then the main barrel 20 may be formed from a UV stabilized material. As another example, the material of the inner barrel 20 may depend on the method used for securing the cable 90 to the female connector 100. For instance, if inner barrel 20 was intended to receive an adhesive for securing the cable 90, then the connector housing 20 would be made from a suitable material to cooperate with the adhesive. Likewise, other components may use different materials as well depending on the desired characteristics or geometry desired.

FIGS. 19 and 20 depict rocker latch arm 70 as discussed herein. This rocker latch arm 70 comprises a pass-through hole (not numbered) at the pivot 70P for attaching the rocker latch arm 70 to the main barrel 60 using retainer 70R such as a pin, screw or the like. The rearward end 70RE of rocker latch arm 70 comprises a spring push 70SP with an alignment feature 70AF for cooperating with the resilient member 75 depicted in FIGS. 21 and 22. The front end 70FE of rocker latch arm 70 comprises a latch 70L. This embodiment of rocker latch arm 70 additionally comprises a pull-back feature 70PBF at the forward end 70FE. Pull-back feature 70PBF aids in retaining the external plug connector (EPC) in the connection port (CP) of female connector 100 in case a pulling force is applied to the external plug connector (EPC), thereby inhibiting an inadvertent removal of the external plug connector (EPC) from the female connector 100. However, the female connector 100 may be designed so that the female connector 100 releases the external plug connector (EPC) at a predetermined pull-out force for inhibiting damage to the female connector 100 if desired.

FIGS. 21 and 22 depict another resilient member 75 that may be used with the female connectors 100 discussed herein. This resilient member 75 is configured as a leaf spring comprising a collar 75C having a cantilevered arm 75CA extending therefrom. The deflection of the cantilevered arm 75 relative to a collar 75C by the spring push 70SP of the rocker latch arm 70 provides the restoring spring force. The cantilevered arm 75CA comprises an alignment feature 75AF for cooperating with the alignment feature 70AF on the rocker latch arm 70 as shown in FIG. 11. Collar 75c is sized so that it may slid onto inner barrel 20 and is used for securing the resilient member 75. Collar 75A comprises an alignment portion 75AP for aiding in the rotational alignment of the resilient member 75 on the inner barrel 20. As discussed herein, female connectors 100 may have different resilient members or constructions as well.

FIGS. 23 and 24 are detailed views of the rear spring push 50. As discussed, spring push 50 comprises a passageway 52 from a spring push front end 53 to a spring push rear end 51. A spring push 50SS also comprises one or more retention features 50W for attaching to the inner barrel 20. As depicted, retention features 50W for cooperating with the latch arms 20LA of inner barrel 20, but other structures are possible for attaching the inner barrel 20 with the spring push 50. Spring push 50 also includes a rear portion with a stepped profile for attaching one or more heat shrinks 97 or boot 99. For instance, spring push 50 may comprise a first portion 57 with a first diameter for attaching a portion of heat shrink 97 to provide an environmental seal between the cable 90 and female connector 100. First portion 57 may comprise one or more ribs 20R for securing the heat shrink 97 in a robust manner. Likewise, spring push 50 may have a second portion 55 with a second diameter for attaching a connector boot 99 and may also have ribs 50R if desired.

FIG. 25 depicts another inner barrel 20 that may be used with female connectors 100 disclosed herein. This inner barrel 20 has a keying feature 20KF so that it may only fit properly within main barrel 60 in one orientation. Moreover, the inner barrel 20 may have geometry tailored for the specific resilient members 75 used in the female connector 100. This inner barrel 20 also comprises latch arms 20LA that have a different orientation for securing to the spring push 50, but they work in a similar fashion as described herein Other geometry may be use for the inner barrel 20 or with other components using the concepts disclosed.

FIGS. 26-40 show an explanatory method for making the fiber optic cable assemblies 200 having female connectors 100 as disclosed herein. Cable assemblies 200 are formed by terminating cable 90 with female connector 100. Other methods may be used for terminating cables 90 with female connectors.

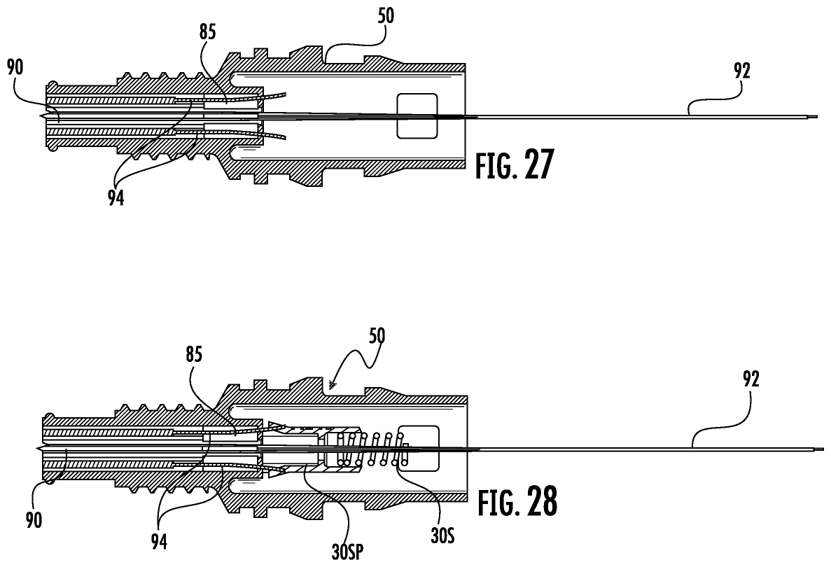

FIG. 26 depicts sliding the desired components of female connector 100 onto the cable 90 having an optical fiber 92. As depicted, boot 99, heat shrink 97 and cap 82 are threaded onto cable 90 in the desired order. Cable 90 may be prepared in any suitable manner and may depend on the type of cable being terminated. Preparation of cable 90 typically comprises exposing the optical fiber 92 and prepping any other cable components as desired for termination such as strength members 94 or cable jacket 98. As best shown in FIG. 27, cable 90 is prepared so that optical fibers 92 and strength members 94 extend beyond cable jacket 98. Strength members 94 may be any suitable type such as rigid glass-reinforced plastic (GRPs) or flexible yarns such as aramid or fiberglass. The cable construction may influence how the cable 90 is secured to the female connector 100, and may be accomplished in a variety of manners.

FIG. 27 depicts a plug 85 and spring push 50 being positioned on the cable 90. Optional plug 80 that may be placed about the optical fibers 92 for inhibiting adhesive or the like from leaking into the forward portion of the spring push 50 of the female connector 100. The forward portion of the spring push provides an area so that the optical fibers are free to move as needed during use. FIG. 28 depicts the ferrule spring push 30SP and ferrule spring 30S being threaded onto the optical fibers 92.

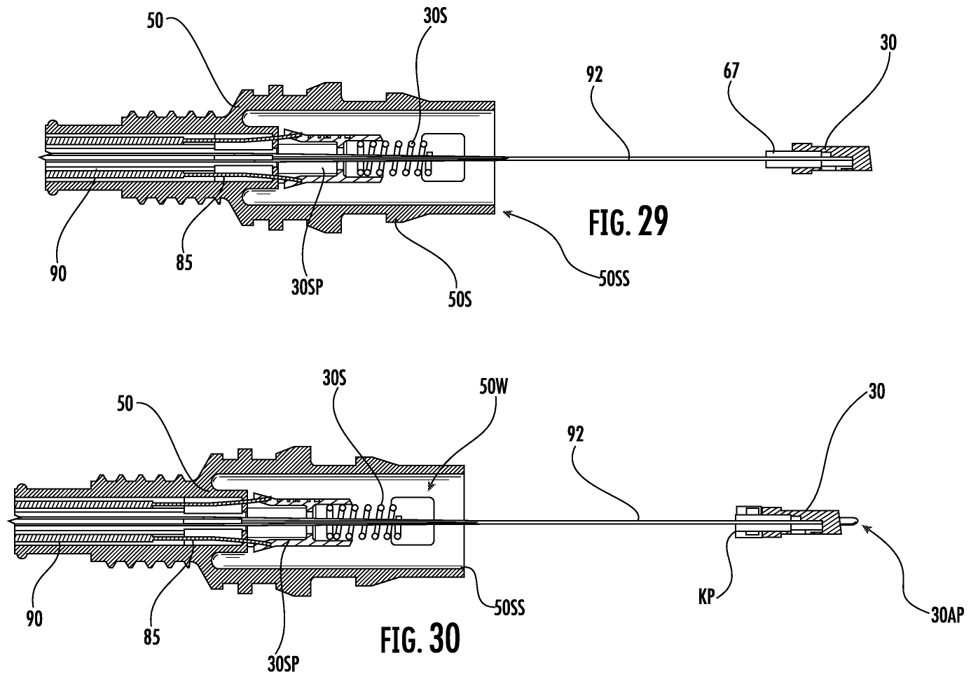

FIG. 29 depicts attaching one or more optical fibers 92 of cable 90 to ferrule 30. Ferrule 30 comprises a plurality of bores 32 for receiving one or more optical fibers 92. Optical fibers 92 are secured to ferrule 30 in a suitable fashion such as adhesive like a UV or heat curable material, but other processes are possible. Thereafter, the end face of ferrule 30 may be polished or finished as known in the art. FIG. 30 shows alignment pins 30AP and/or pin keeper being attached to the ferrule 30 if used.

FIG. 31 is a detailed view of ferrule 30 showing optical fibers 92 at the front face of ferrule 30. As depicted, ferrule 30 may comprise a ferrule body having ferrule shoulder 30S at the rear along with alignment bores 30B for receiving alignment pins as known in the art. If a ferrule boot 67 is used, then the optical fibers 92 are threaded through the ferrule boot 67 before inserting and attaching the optical fibers to the ferrule 30.

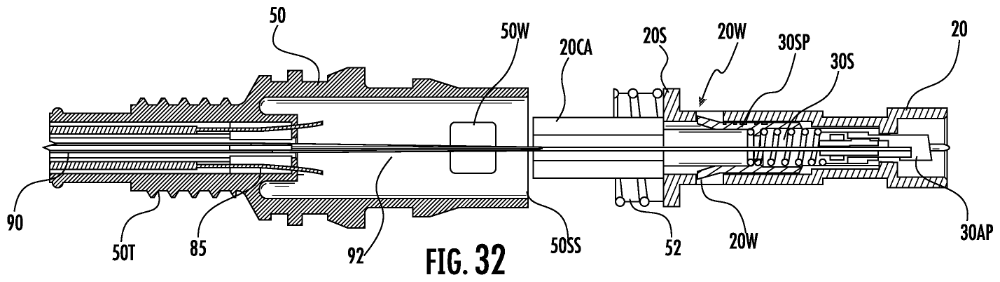

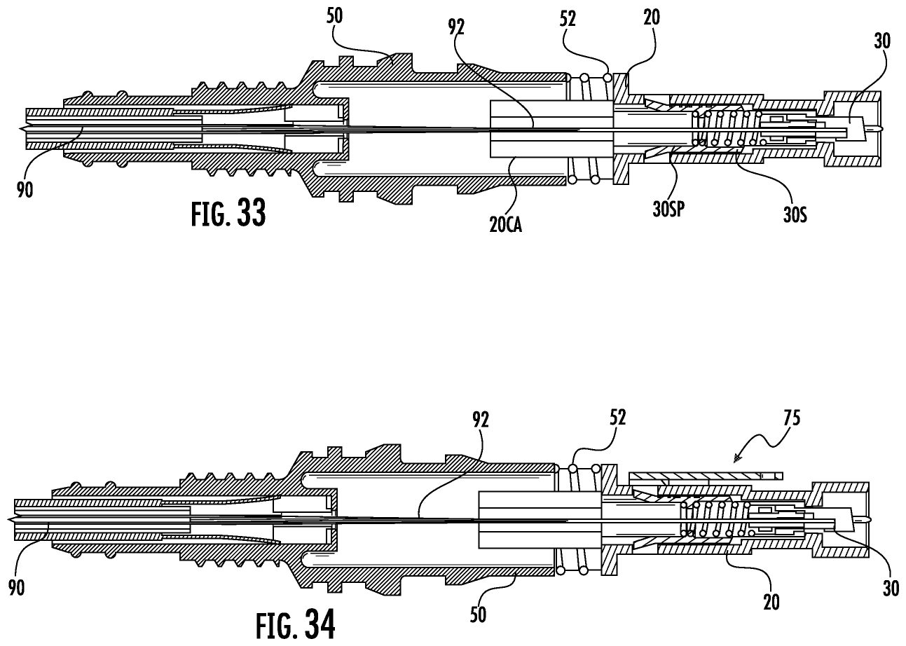

FIG. 32 depicts inserting the ferrule 30 into a passageway 22 of inner barrel 20 by inserting the ferrule 30 from the inner barrel rear opening 21o. The ferrule spring 30S and ferrule spring push 30SP are slid up into inner housing so that the spring push 30SP is attached to the inner barrel 20 as discussed herein. Thus, ferrule 30 is biased to the forward position by ferrule spring 30S. FIG. 33 depicts the inner barrel 20 attached to the rear spring push 50 and capturing spring 52 between the inner barrel 20 and rear spring push 50 as shown.

Cable 90 may be secured to the spring push at any suitable step during the process. Rear spring push 50 may have one or more apertures 50A for placing an adhesive such as epoxy, glue, resin s radiation-curable, polymer (cured using an ultrasonic or induction welding process) or other such materials for securing cable 90 to the rear spring push 50. The adhesive or the like is placed into the rear spring push 50 for securing the cable 90 to female connector 100. A second aperture on spring push 50 allows air to escape and adhesive or the like to wick about the cable 90 and fill the passageway 52 of spring push 522. The adhesive may secure the cable 90, one or more optical fibers 92 and one or more strength members 94 to the female connector 100 for strain relief if desired. As used herein, “adhesive” means any suitable material for securing the cable 90 to connector housing 20.

Of course, the spring push 50 may be secured to cable 90 or a portion of cable 90 in any suitable fashion. For instance, rear spring push 50 may be terminated or secured to strength members 94 of cable 90 using other manners such as a crimp if desired. The type of strength members 94 may depend on the type of cable terminated to the connector and may include tensile yarns, fiberglass rods or the like. The concepts of female connector 100 may be modified to use any suitable cable type such as by modifying the passageway of the spring push 50 and/or other components as desired.

Fiber optic cable assemblies may be formed by securing the fiber optic cable to the female connector in any suitable fashion such as using an adhesive, crimp or the like, but other methods of attaching the cable to connector are possible. Consequently, the disclosed connector design is highly-adaptable to a wide variety of fiber optic cables of various shapes and/or construction for different customer requirements or preferences. For instance, the connector may be terminated to fiber optic cables comprising a round cross-section or a non-round cross-section as desired. Likewise, the connector may be terminated to cables having rigid strength members such as GRPs or flexible yarn-like strength members such as aramid, fiberglass or the like.

In other variations, the outer jacket or strength members could be shaved to fit inside the passageway 52 of rear spring push 50 to fit an oversized cable or shaping the cable to the passageway 52. Moreover, shaving the cable 90 may improve the adhesion to the cable 90.

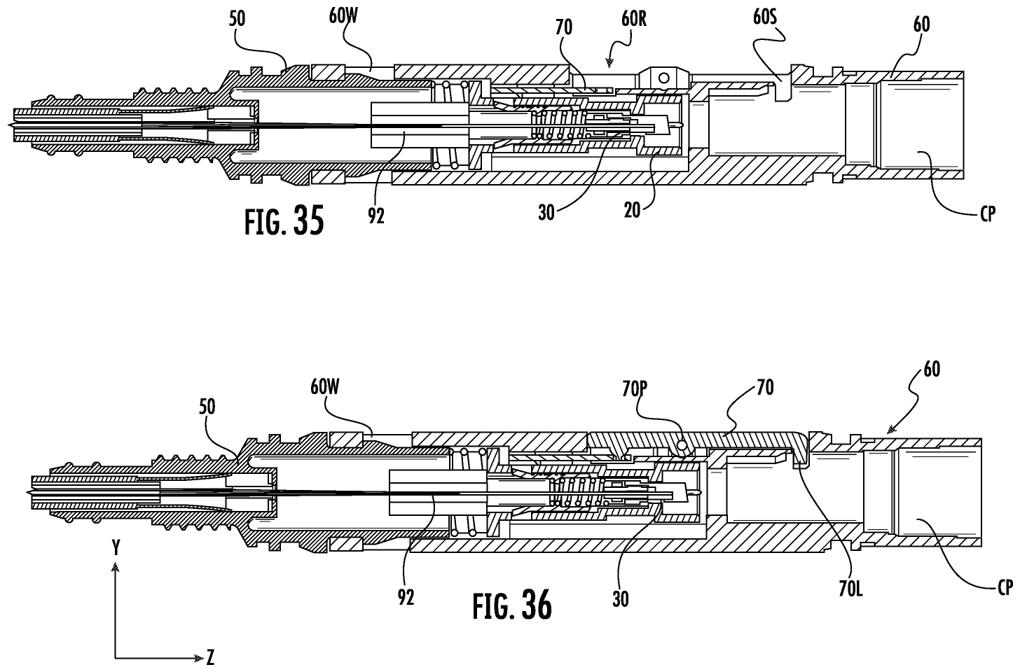

FIG. 34 depicts placing the one or more resilient members 75 on the female connector 100. In this embodiment, resilient member 75 is slid onto the inner barrel 20, but other constructions may place the resilient members 75 in place after the main barrel is attached. FIG. 35 depicts placing the inner barrel 20 within the main barrel 60 from the main barrel rear opening 610 sized for receiving the inner barrel. FIG. 36 depicts attaching the rocker latch arm 70 to the main barrel 60.

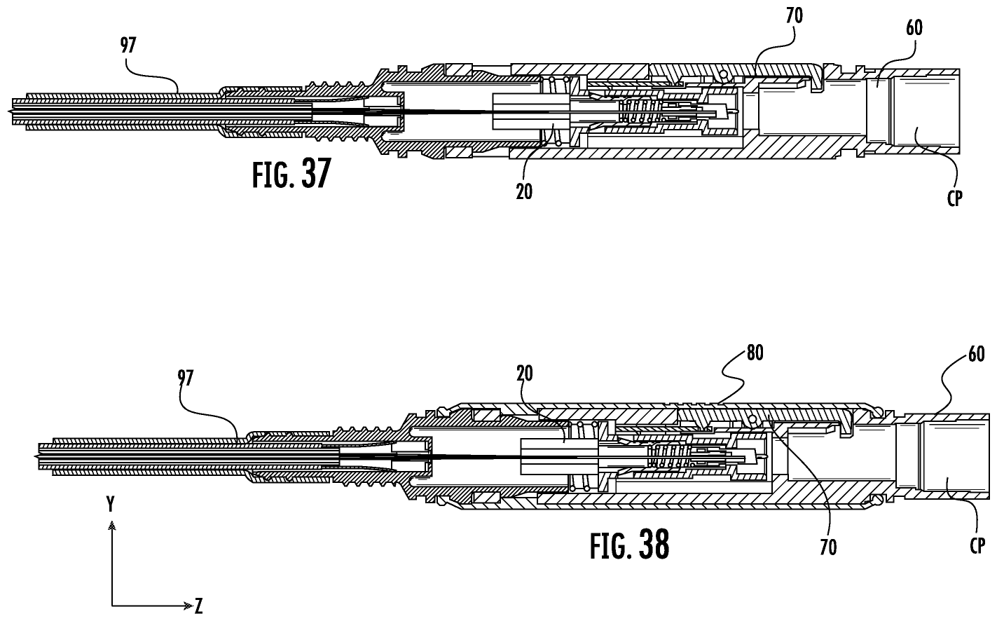

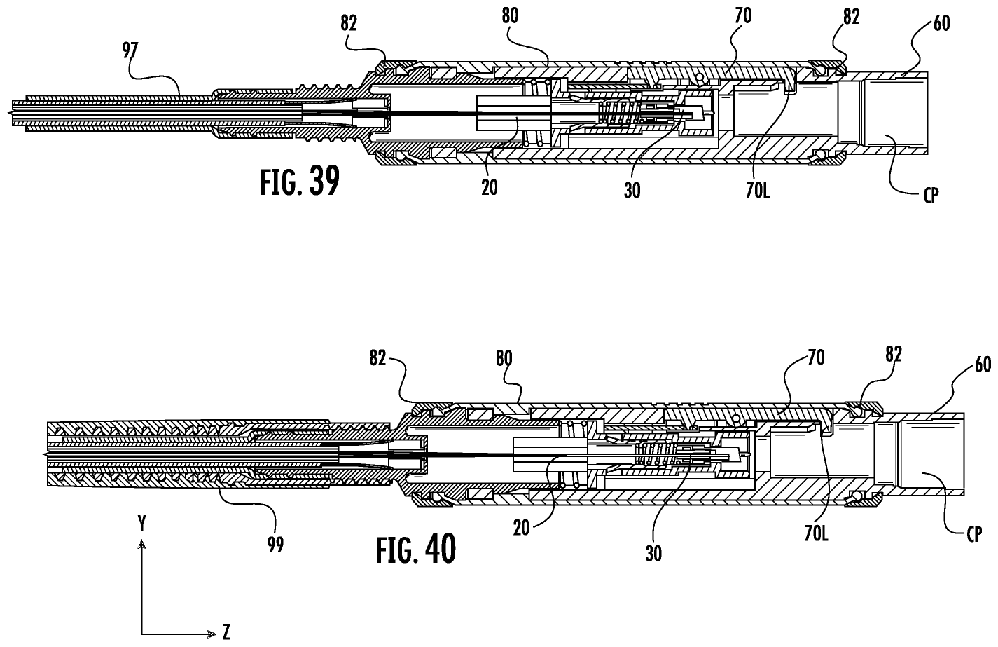

FIG. 37 shows heat shrink 97 that may be installed over the rear portion of the rear spring push 50 and a portion of cable 90. Rear spring push 50 may have on or more ribs for providing a gripping surface for the heat shrink 97. Using a heat shrink aids in making a weather-proof interface between the cable 90 and connector 100 Any suitable size or type of heat shrink such as an adhesive lined heat shrink may be used for sealing or securing components as desired. FIG. 38 shows weatherproofing collar 80 placed about a portion of the main barrel 60, and FIG. 39 depicts the caps 82 attached at the respective ends of the weatherproofing collar 80.

FIG. 40 depicts a boot 99 attached to a rear portion of rear spring push 50. Ribs may also be used for providing a gripping surface for boot 99 if desired. Boot 99 may not omitted if desired, but can provided improved side-pull performance for the cable assembly.

The concepts disclosed also enable smaller footprints for the female connector 100. By way of example, female connector 100 may have an outer diameter of 18 millimeters or smaller, or may even be 15 millimeters of smaller for the outer diameter taken transverse to the longitudinal axis of the female connector looking into the connection port opening (CPO) but other sizes are possible.

Explanatory female connectors 100 avoid bulky mating structures such as a coupling nut or bayonet used with conventional connectors. In other words, conventional connectors have threaded, bayonet, or push-pull connections that require finger access for connection and disconnecting. By eliminating the structures such as threaded coupling nuts or bayonets (which is a separate component that must rotate about the connector) the size of the female connector may be reduced while also allowing quick and easy mating with the external plug connector. Also eliminating the dedicated coupling nut from the conventional connectors also allows the footprint of the connectors to be smaller, and arrays of connectors to likewise be more compact.

Other variations and modifications are possible for the female connector concepts disclosed. By way of explanation, FIGS. 41-52 depict views of another explanatory female fiber optic connector having an actuator similar to the explanatory female fiber optic connector of FIG. 8, but uses two resilient members 75 for biasing the actuator to a normally retain position such as depicted in FIGS. 4C and 4D. As shown in the cross-sectional view of FIG. 42, this design of female connector 100 is similar to the embodiments described herein, but may be easier to assemble and/or manufacture and most of the parts are the same or similar to those described herein.

By way of explanation, this embodiment of female connector 100 also comprises a spring seat 29 for resilient member 52 as depicted in FIG. 42. Spring seat 29 is a separate component for aiding in the assembly of the female connector 100, compared with the spring seat that was integrally formed in the inner barrel 20 as a shoulder and shown in FIG. 15 of the connector of FIG. 8. The spring seat 29 is configured as a collar that can slide over a rear end 21 of the inner barrel 20 and be attached by rotating relative to the inner barrel 20, thereby allowing the piece to move until attached. Using a separate spring seat 29 allows more room for optical fiber movement or manipulation during assembly. Additionally, the inner barrel 20 of this embodiment does not include latch arms that cooperate with the spring push 50 shown in FIG. 15. sealing portions 80SL may have enlarged lips about the perimeter, thereby providing material that may be compressed for creating a weatherproof seal at the ends of the weatherproofing collar 80.

FIGS. 43-46 depict inner barrel 20 of the embodiment of FIG. 41 that is similar to the inner barrel 20 of FIG. 8. This embodiment of female connector 100 comprises a spring seat 29 that is a separate component as shown. Inner barrel 20 comprises an inner barrel rear end 21 and an inner barrel front end 23 with an inner barrel passageway 22 extending from the inner barrel rear end 21 to the inner barrel front end 23. The inner barrel rear end 21 of inner barrel 20 comprises an inner barrel rear end opening 210 sized for receiving the ferrule 30.

To assemble the ferrule 30 within the inner barrel 20 of female connector 100 the optical fibers 92 of fiber optic cable 90 are attached to ferrule 30, and then the alignment pins 30AP may be attached to the ferrule if used. The ferrule 30 with the alignment pins 30AP may be inserted into the inner barrel 20 from the inner barrel rear end opening 210 and the spring 30S and a ferrule spring push 30SP are slid forward so the spring push 30SP is attached to the inner barrel 20 using windows 20W for a snap-fit assembly and biasing the ferrule 30 to a forward position within the inner barrel 20 as discussed herein.

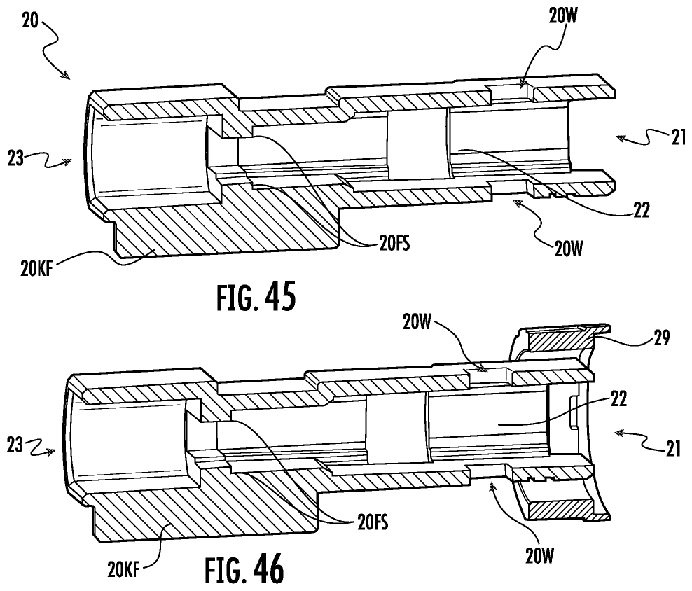

Inner barrel 20 also comprises a ferrule stop 20FS within the longitudinal passageway 22 acting as a forward stop for the ferrule 30 as shown in FIGS. 45 and 46. Spring 30S biases the ferrule 30 forward to the ferrule stop 20FS. Ferrule stop 20FS limits travel of the ferrule 30 to the front of inner barrel 20, but the ferrule 30 is allowed to move rearward during mating as needed subject to the restoring forward-force of the spring 30S. Spring 30S aids in maintaining physical contact between optical fibers 92 disposed in the ferrule 30 when the female connector is in a mated state for optical connection. Ferrule stop 20FS also defines a window (not numbered) for coarse alignment of the ferrule 30 within the inner barrel 20. In this embodiment, the ferrule window is a rectangular opening sized for an MT ferrule, but other shapes or sized may be used depending on the type of ferrule used in the female connector 100. As discussed herein, the window adjacent to ferrule stop 20FS is sized for a ferrule width FW and a ferrule height FH, while not allowing a ferrule shoulder 30S to pass thru the window of the inner barrel 20. Likewise, this female connector 100 may allow limited movement or “float” of the ferrule within the connector in the unmated state for allowing limited movement of the ferrule during mating with a complimentary device.

Likewise, this inner barrel 20 has a keying feature 20KF so that it may only fit properly within main barrel 60 in one orientation. Moreover, the inner barrel 20 may have geometry tailored for the specific resilient members 75 used in the female connector 100.

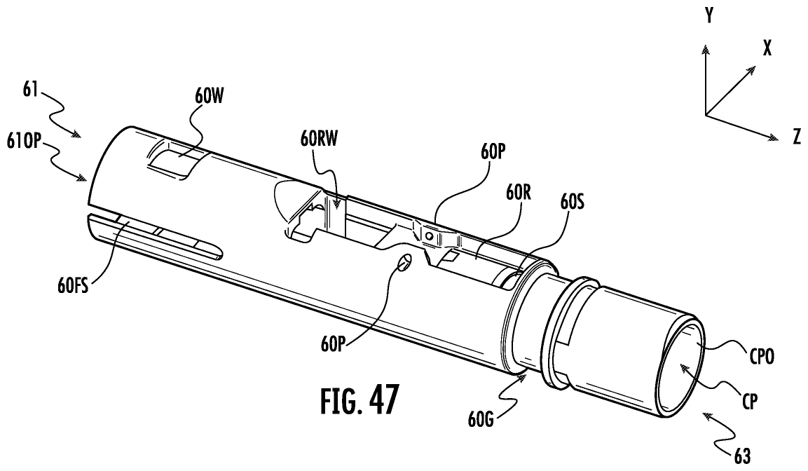

FIG. 47 shows main barrel 60 of FIG. 41 comprising the main barrel rear end 61 and the main barrel front end 63 with the main barrel passageway 62 extending from the main barrel rear end 61 to the main barrel front end 63. The main barrel rear end 61 comprises the main barrel rear end opening 610 sized for receiving the inner barrel 20, and the main barrel front end 63 comprises the connection port opening (CPO). The connector port opening leads to a connection port (CP) that forms a cavity for receiving a portion of the external plug connector (EPC) as shown.

Main barrel 60 may also comprises recess 60R shaped for receiving a portion of the rocker latch arm 70. The shape and size of the recess may depend on the specific rocker latch arm 70 used. Main barrel 60 may also comprise at least one slot 60S sized for receiving a latch 70L of the rocker latch arm 70. Slot 60S allow a portion of the rocker latch arm 70 to protrude into the connection port (CP) when in the retain position. As depicted in this embodiment, the slot 60s is disposed in the recess 60R.

Main barrel 60 also includes pivot 60P formed therein. The pivot 60R allows attachment of the actuator or rocker latch arm 70 thereto in a pivoting manner. The pivot may allow direct attachment of the rocker latch arm or attachment of retainer 70R for attachment of the rocker latch arm 70 as desired. The main barrel 70 may also include recess window 60RW rearward of the pivot 60P for allowing the rear end 70RE of the rocker latch arm to engage with the one or more resilient members 75. Main barrel 60 may also comprise one or more retention features for attachment. For instance, the main barrel 60 may comprise one or more windows 60W for attaching the main barrel 60 to the spring push 50. This embodiment of main barrel 60 also include flexure slots 60FS for aiding assembly.

Main barrel 60 has a generally round shape or cylindrical sleeve with one or more features integrally formed in the primitive geometry of the cylindrical sleeve as discussed and shown. For instance, main barrel may also comprise a groove 60G. Groove 60G and/or other structure that may allow for the compression of the end of the weatherproofing collar 80 using cap 82 at the front end or receiving adhesive, welding materials or the like if desired. For instance, weatherproofing collar 80 may have sealing portions 80SL with enlarged lips about the perimeter such as a O-ring type-shape, thereby providing material that may be compressed for creating a weatherproof seal at the ends of the weatherproofing collar 80. Likewise, the spring push 50 may have a groove 50G and/or other structure that may allow for the compression of the end of the weatherproofing collar 80 using cap 82 at the rear end.

The female connector 100 of FIG. 41 may include other features or structure as discussed. For instance, the female connector 100 may include an interface between the inner barrel 20 and main barrel 60 with one or more clocking features for rotational alignment during assembly.

FIGS. 48 and 49 depict detailed views of rocker latch arm 70 of the female connector 100. This rocker latch arm 70 comprises a pass-through hole (not numbered) at the pivot 70P for attaching the rocker latch arm 70 to the main barrel 60 using retainer 70R such as a pin, screw or the like. The rearward end 70RE of rocker latch arm 70 comprises two spring pushes 70SP located at the outboard wings on opposite sides with each spring push 70SP having a respective alignment feature 70AF for cooperating with the resilient member 75 such as the coil spring. The front end 70FE of rocker latch arm 70 comprises a latch 70L as discussed herein.

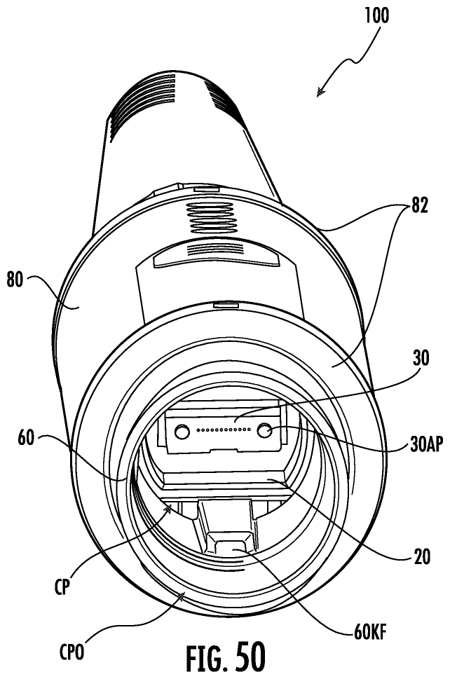

FIG. 50 shows an end view into female connector 100. As shown, main barrel 20 comprises keying feature 60KF disposed within the connection port (CP). The keying feature 20KF is integrally formed in the main barrel 60 as a male keying feature. In this case, the keying feature 60KF protrudes from an inner wall of the main barrel 60 for cooperating with the keying portion 101KP on the dust plug 101 or the keying portion KP on the external plug connector (EPC). Keying feature 60KF of main barrel may have any suitable orientation relative to the rocker latch arm 70. In this case, the rocker latch arm 70 is disposed on the opposite side from the keying feature 60KP (i.e., about 180 degrees apart) on the main barrel 60.

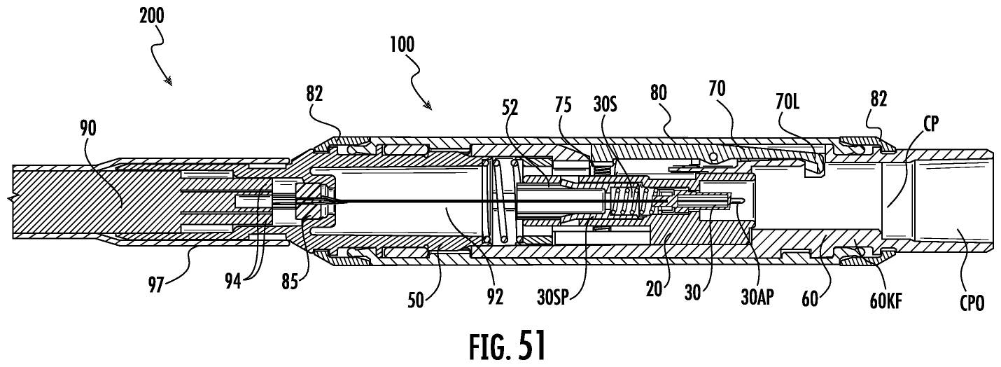

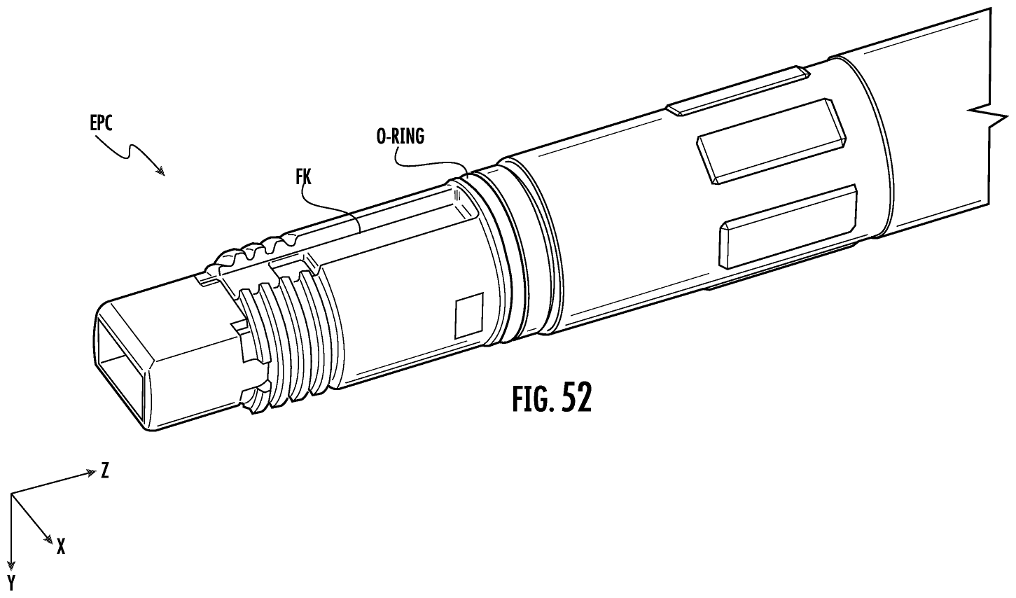

The concepts disclosed may be used with any suitable fiber optic cable as desired using simple modification of one or more parts. By way of example, FIG. 51 shows the female connector configured for a flat drop cable 90. As shown, this embodiment uses a modified spring push 50 having a rear portion of the passageway sized for receiving the flat drop cable. As discussed, the fiber optic cable 90, strength members 94 and/or optical fibers 92 may be secured using an adhesive injected into the spring push 50 from an aperture located rearward of the plug 85. Plug 85 inhibits adhesive from wicking forward of the plug 85. Different fiber optic cables 90 may also require different cable preparation for use with the female connector 100.

FIGS. 52 and 53 depict detailed perspective views of the external plug connector (EPC) shown in FIG. 3. External plug connector (EPC) may comprise one or more O-rings 65 that may be used to seal the mated optical connection.

Although the disclosure has been illustrated and described herein with reference to explanatory embodiments and specific examples thereof, it will be readily apparent to those of ordinary skill in the art that other embodiments and examples can perform similar functions and/or achieve like results. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application cover the modifications and variations provided they come within the scope of the appended claims and their equivalents.

We claim:

1. A female fiber optic connector having a connection port for receiving a mating fiber optic plug, comprising:
a ferrule comprising one or more bores for receiving one or more optical fibers;
a main barrel comprising a main barrel rear end and a main barrel front end with a main barrel passageway extending from the main barrel rear end to the main barrel front end, and the main barrel front end comprises a connection port opening;
an actuator capable of translating for releasing a mated fiber optic plug from the connection port opening; and
a weatherproofing collar disposed rearward of the connection port opening and disposed about a portion of the main barrel and the actuator.

2. The female fiber optic connector of claim 1, further comprising one or more resilient members for biasing the actuator to a retain position.

3. A female fiber optic connector having a connection port for receiving a mating fiber optic plug, comprising:
a ferrule comprising one or more bores for receiving one or more optical fibers;
a main barrel comprising a main barrel rear end and a main barrel front end with a main barrel passageway extending from the main barrel rear end to the main barrel front end, and the main barrel front end comprises a connection port opening;
a rocker latch arm comprising a pivot suitable for pivoting the rocker latch arm relative to the main barrel;
one or more resilient members for biasing the rocker latch arm to a retain position; and
a weatherproofing collar disposed rearward of the connection port opening and disposed about a portion of the main barrel and the rocker arm latch.

4. The female fiber optic connector of claim 3, wherein a portion of the one or more resilient member cooperates with a rear end of the rocker latch arm.

5. A female fiber optic connector having a connection port for receiving a mating fiber optic plug, comprising:
a ferrule comprising one or more bores for receiving one or more optical fibers;
an inner barrel comprising an inner barrel rear end and an inner barrel front end with an inner barrel passageway extending from the inner barrel rear end to the inner barrel front end, wherein the inner barrel rear end comprises an inner barrel rear end opening sized for receiving the ferrule;
a main barrel comprising a main barrel rear end and a main barrel front end with a main barrel passageway extending from the main barrel rear end to the main barrel front end, wherein the main barrel rear end comprises a main barrel rear end opening sized for receiving the inner barrel and the main barrel front end comprises a connection port opening;
a rocker latch arm comprising a pivot suitable for pivoting the rocker latch arm relative to the main barrel, and comprising a latch and a rear end;
one or more resilient members for biasing the rocker latch arm to a retain position, wherein a portion of the one or more resilient members cooperates with the rear end of the rocker latch arm; and
a weatherproofing collar disposed rearward of the connection port opening and disposed about a portion of the main barrel and the rocker arm latch.

6. The female fiber optic connector of claim 1, further comprising a rear spring push suitable for attaching to the main barrel.

7. A female fiber optic connector having a connection port for receiving a mating fiber optic plug, comprising:
a ferrule comprising one or more bores for receiving one or more optical fibers;
an inner barrel comprising an inner barrel rear end and an inner barrel front end with an inner barrel passageway extending from the inner barrel rear end to the inner barrel front end, wherein the inner barrel rear end comprises an inner barrel rear end opening sized for receiving the ferrule;
a main barrel comprising a main barrel rear end and a main barrel front end with a main barrel passageway extending from the main barrel rear end to the main barrel front end, wherein the main barrel rear end comprises a main barrel rear end opening sized for receiving the inner barrel and the main barrel front end comprises a connection port opening;
a rocker latch arm comprising a pivot suitable for pivoting the rocker latch arm relative to the main barrel, and comprising a latch and a biasing end;
one or more resilient members for biasing the rocker latch arm to a retain position, wherein a portion of the one or more resilient members cooperates with the rear end of the rocker latch arm;
a rear spring push suitable for attaching to the main barrel; and
a weatherproofing collar disposed rearward of the connection port opening and disposed about a portion of the main barrel and the rocker arm latch.

8. The female fiber optic connector of claim 1, further comprising a spring for biasing the inner barrel to a forward position.

9. A female fiber optic connector having a connection port for receiving a mating fiber optic plug, comprising:
a ferrule comprising one or more bores for receiving one or more optical fibers;
an inner barrel comprising an inner barrel rear end and an inner barrel front end with an inner barrel passageway extending from the inner barrel rear end to the inner barrel front end, wherein the inner barrel rear end comprises an inner barrel rear end opening sized for receiving the ferrule;
a main barrel comprising a main barrel rear end and a main barrel front end with a main barrel passageway extending from the main barrel rear end to the main barrel front end, wherein the main barrel rear end comprises a main barrel rear end opening sized for receiving the inner barrel and the main barrel front end comprises a connection port opening;
a rocker latch arm comprising a pivot suitable for pivoting the rocker latch arm relative to the main barrel, and comprising a latch and a rear end;
one or more resilient members for biasing the rocker latch arm to a retain position, wherein a portion of the one or more resilient members cooperates with the rear end of the rocker latch arm;
a rear spring push;
a spring for biasing the inner barrel to a forward position in the main barrel; and
a weatherproofing collar disposed rearward of the connection port opening and disposed about a portion of the main barrel and the rocker arm latch.

10. The female fiber optic connector of claim 1, further comprising at least one cap disposed about an end of the weatherproofing collar.

11. A female fiber optic connector having a connection port for receiving a mating fiber optic plug, comprising:
a ferrule comprising one or more bores for receiving one or more optical fibers;
an inner barrel comprising an inner barrel rear end and an inner barrel front end with an inner barrel passageway extending from the inner barrel rear end to the inner barrel front end, wherein the inner barrel rear end comprises an inner barrel rear end opening sized for receiving the ferrule;
a main barrel comprising a main barrel rear end and a main barrel front end with a main barrel passageway extending from the main barrel rear end to the main barrel front end, wherein the main barrel rear end comprises a main barrel rear end opening sized for receiving the inner barrel and the main barrel front end comprises a connection port opening;
a rocker latch arm comprising a pivot suitable for pivoting the rocker latch arm relative to the main barrel;
one or more resilient members for biasing the rocker latch arm to a retain position, wherein a portion of the one or more resilient members cooperates with a rear end of the rocker latch arm;
a rear spring push suitable for attaching to the main barrel;
a spring for biasing the inner barrel to a forward position in the main barrel;
a weatherproofing collar disposed rearward of the connection port opening and sized for being disposed about a portion of the main barrel; and
at least one cap disposed about an end of the weatherproofing collar.

12. The female fiber optic connector of claim 3, wherein a portion of the one or more resilient members is disposed between the inner barrel and the rocker latch arm.

13. A female fiber optic connector having a connection port for receiving a mating fiber optic plug, comprising:
a ferrule comprising one or more bores for receiving one or more optical fibers;
an inner barrel comprising an inner barrel rear end and an inner barrel front end with an inner barrel passageway extending from the inner barrel rear end to the inner barrel front end, wherein the inner barrel rear end comprises an inner barrel rear end opening sized for receiving the ferrule;
a main barrel comprising a main barrel rear end and a main barrel front end with a main barrel passageway extending from the main barrel rear end to the main barrel front end, wherein the main barrel rear end comprises a main barrel rear end opening sized for receiving the inner barrel and the main barrel front end comprises a connection port opening;
a rocker latch arm comprising a pivot suitable for pivoting the rocker latch arm relative to the main barrel;
one or more resilient members for biasing the rocker latch arm to a retain position, wherein a portion of the one or more resilient members is disposed between the inner barrel and the rocker latch arm;
a rear spring push suitable for attaching to the main barrel;
a spring for biasing the inner barrel to a forward position in the main barrel;
a weatherproofing collar disposed rearward of the connection port opening and sized for being disposed about a portion of the main barrel; and
at least one cap disposed about an end of the weatherproofing collar.

14. The female fiber optic connector of claim 8, the rear spring push comprising a cable strain relief portion.

15. A female fiber optic connector having a connection port for receiving a mating fiber optic plug, comprising:
a ferrule comprising one or more bores for receiving one or more optical fibers;
an inner barrel comprising an inner barrel rear end and an inner barrel front end with an inner barrel passageway extending from the inner barrel rear end to the inner barrel front end, wherein the inner barrel rear end comprises an inner barrel rear end opening sized for receiving the ferrule;
a main barrel comprising a main barrel rear end and a main barrel front end with a main barrel passageway extending from the main barrel rear end to the main barrel front end, wherein the main barrel rear end comprises a main barrel rear end opening sized for receiving the inner barrel and the main barrel front end comprises a connection port opening;
a rocker latch arm comprising a pivot suitable for pivoting the rocker latch arm relative to the main barrel;
one or more resilient members for biasing the rocker latch arm to a retain position, wherein a portion of the one or more resilient members is disposed between the inner barrel and the rocker latch arm;
a rear spring push comprising a cable strain relief portion, wherein the rear spring push is suitable for attaching to the main barrel;
a spring for biasing the inner barrel to a forward position in the main barrel; and
a weatherproofing collar disposed rearward of the connection port opening and sized for being disposed about a portion of the main barrel.

16. The female fiber optic connector of claim 1, the main barrel further comprising a keying feature.

17. A female fiber optic connector having a connection port for receiving a mating fiber optic plug, comprising:
a ferrule comprising one or more bores for receiving one or more optical fibers;
an inner barrel comprising an inner barrel rear end and an inner barrel front end with an inner barrel passageway extending from the inner barrel rear end to the inner barrel front end, wherein the inner barrel rear end comprises an inner barrel rear end opening sized for receiving the ferrule;
a main barrel comprising a main barrel rear end and a main barrel front end with a main barrel passageway extending from the main barrel rear end to the main barrel front end, wherein the main barrel rear end comprises a main barrel rear end opening sized for receiving the inner barrel and the main barrel front end comprises a connection port opening, and comprising a keying feature;
a rocker latch arm comprising a pivot suitable for pivoting the rocker latch arm relative to the main barrel;
one or more resilient members for biasing the rocker latch arm to a retain position, wherein a portion of the one or more resilient members is disposed between the inner barrel and the rocker latch arm;
a rear spring push comprising a cable strain relief portion, wherein the rear spring push is suitable for attaching to the main barrel;
a spring for biasing the inner barrel to a forward position in the main barrel; and
a weatherproofing collar disposed rearward of the connection port opening and sized for being disposed about a portion of the main barrel.

18. The female fiber optic connector of claim 17, the keying feature being a male keying feature.

19. The female fiber optic connector of claim 17, wherein the key feature is disposed about 180 degrees apart from the rocker latch arm.

20. A female fiber optic connector having a connection port for receiving a mating fiber optic plug, comprising:
a ferrule comprising one or more bores for receiving one or more optical fibers;
an inner barrel comprising a rear end and a front end with a longitudinal passageway extending from the rear end to the front end, wherein the rear end comprises a rear end opening sized for receiving the ferrule;
a main barrel comprising a rear end and a front end with a longitudinal passageway extending from the rear end to the front end, wherein the rear end comprises a rear end opening sized for receiving the inner barrel and the front end comprises a connection port opening, and comprising a keying feature configured as a male keying feature;
a rocker latch arm comprising a pivot suitable for pivoting the rocker latch arm relative to the main barrel, wherein the rocker latch arm is disposed on the opposite side from the keying feature;
one or more resilient members for biasing the rocker latch arm to a retain position, wherein a portion of the one or more resilient members is disposed between the inner barrel and the main barrel;
a rear spring push comprising a cable strain relief portion, wherein the rear spring push is suitable for attaching to the main barrel;
a spring for biasing the inner barrel to a forward position; and
a weatherproofing collar disposed rearward of the connection port opening and sized for being disposed about a portion of the main barrel.

21. The female fiber optic connector of claim 1, wherein the weatherproofing collar comprises one or more ends sealed by an adhesive, a crimp-band, a clip, heat-staking or ultra-sonic welding.

22. The female fiber optic connector of claim 1, the weatherproofing collar comprising an end portion with an integrally-formed sealing portion.

23. The female fiber optic connector of claim 1, further comprising one or more caps that cooperate with the weatherproofing collar.

24. The female fiber optic connector of claim 23, wherein the one or more caps compress a portion of the weatherproofing collar.

25. The female fiber optic connector of claim 24, wherein the one or more caps may rotate for engaging the weatherproofing collar.

26. A female fiber optic connector having a connection port for receiving a mating fiber optic plug, comprising:
a ferrule comprising one or more bores for receiving one or more optical fibers;
an inner barrel comprising a rear end and a front end with a longitudinal passageway extending from the rear end to the front end, wherein the rear end comprises a rear end opening sized for receiving the ferrule;
a main barrel comprising a rear end and a front end with a longitudinal passageway extending from the rear end to the front end, wherein the rear end comprises a rear end opening sized for receiving the inner barrel and the front end comprises a connection port opening, and comprising a keying feature configured as a male keying feature;
a rocker latch arm comprising a pivot suitable for pivoting the rocker latch arm relative to the main barrel, wherein the rocker latch arm is disposed on the main barrel opposite from the keying feature;
one or more resilient members for biasing the rocker latch arm to a retain position, wherein a portion of the one or more resilient members is disposed between the inner barrel and the rocker latch arm;
a rear spring push comprising a cable strain relief portion, wherein the rear spring push is suitable for attaching to the main barrel;
a spring for biasing the inner barrel to a forward position in the main barrel; and
a weatherproofing collar disposed rearward of the connection port opening and sized for being disposed about a portion of the main barrel, and the weatherproofing collar comprising an end portion with an integrally-formed sealing portion comprising an enlarged lip; and
one or more caps that cooperate with the weatherproofing collar.

27. The female fiber optic connector of claim 3, wherein the rocker latch arm comprises a portion that protrudes into the connection port when in a retain position.

28. The female fiber optic connector of claim 2, wherein the one or more resilient members comprising a coil spring, a leaf spring, a wave spring, or a torsional spring.

29. The female fiber optic connector of claim 2, wherein the one or more resilient members is a coil spring.

30. The female fiber optic connector of claim 2, wherein the one or more resilient members are a first coil spring and a second coil spring.

31. The female fiber optic connector of claim 2, wherein the one or more resilient members provide a downward retention force for maintaining the rocker latch arm in the retain position between 5 Newtons and 15 Newtons.

32. The female fiber optic cable assembly of claim 1, wherein the main barrel comprises one or more windows.

33. The female fiber optic connector of claim 3, wherein the main barrel comprises a recess shaped for receiving a portion of the rocker latch arm.

34. The female fiber optic connector of claim 5, wherein an interface between the inner barrel and the main barrel comprises one or more clocking features for rotational alignment.

35. The female fiber optic connector of claim 3, the main barrel further comprising at least one slot sized for receiving a latch of the rocker latch arm.

36. The female fiber optic connector of claim 1, the ferrule is allowed limited movement between about 100-400 microns of movement in two degrees of freedom in the unmated state.

37. The female fiber optic connector of claim 26, wherein the weatherproofing collar comprises one or more ends sealed by an adhesive, a crimp-band, a clip, heat-staking or ultra-sonic welding.

38. The female fiber optic connector of claim 26, wherein the one or more caps compress a portion of the weatherproofing collar.

39. The female fiber optic connector of claim 26, wherein the one or more caps rotate for engaging the weatherproofing collar.

40. The female fiber optic connector of claim 1, wherein the weatherproofing collar is formed from an elastomeric material.

41. The female fiber optic connector of claim 1, wherein the fiber optic connector is a portion of a cable assembly comprising a fiber optic cable.

42. The female fiber optic connector of claim 41, wherein the fiber optic cable is secured to the spring push using a crimp band, adhesive, epoxy, or glue.

43. The female fiber optic connector of claim 41, wherein the fiber optic cable comprises one or more tensile yarns that are secured to the spring push.

44. The female fiber optic connector of claim 41, wherein the fiber optic cable comprises a round cross-section or a non-round cross-section.

45. The female fiber optic connector of claim 1, further comprising one or more heat shrinks.

46. The female fiber optic connector of claim 1, further comprising a ferrule boot having a portion that fits within the ferrule.

47. The female fiber optic connector of claim 1, further comprising a connector boot.

48. A method of making a fiber optic cable assembly comprising a female fiber optic connector having a connection port, the method comprising:
attaching one or more optical fibers of a fiber optic cable to a ferrule;
inserting the ferrule into a passageway of an inner barrel, wherein the inner barrel comprises an inner barrel rear end and an inner barrel front end with an inner barrel passageway extending from the inner barrel rear end to the inner barrel front end, wherein the inner barrel rear end comprises an inner barrel rear end opening sized for receiving the ferrule;
placing the inner barrel within a main barrel, the main barrel comprising a main barrel rear end and a main barrel front end with a main barrel passageway extending from the main barrel rear end to the main barrel front end, wherein the main barrel rear end comprises a main barrel rear end opening sized for receiving the inner barrel and the main barrel front end comprises a connector port opening;
attaching an actuator to the main barrel; and
positioning a weatherproofing collar rearward of the connection port opening about a portion of the main barrel and the actuator.

49. The method of claim 48, wherein the actuator is configured as a rocker latch arm.

50. The method of claim 49, installing one or more resilient members for biasing the rocker latch arm to a retain position.

51. The method of claim 50, wherein the one or more resilient members are a first coil spring and a second coil spring.

52. The method of claim 50, wherein the one or more resilient members comprises a coil spring, a leaf spring, a wave spring, or a torsional spring.

53. The method of claim 48, wherein the weatherproofing collar comprises one or more ends sealed by an adhesive, a crimp-band, a clip, heat-staking or ultra-sonic welding.

54. The method of claim 48, the weatherproofing collar comprising an end portion with an integrally-formed sealing portion.

55. The method of claim 48, further comprising placing one or more caps about a portion of the weatherproofing collar.

56. The method of claim 55, wherein the one or more caps compress a portion of the weatherproofing collar.

57. The method of claim 55, wherein the one or more caps are rotated for engaging the weatherproofing collar.

58. The method of claim 48, wherein the main barrel further comprises at least one slot sized for receiving a latch of the rocker latch arm.

59. The method of claim 48, wherein the main barrel comprises a recess shaped for receiving a portion of the rocker latch arm.

60. The method of claim 48, wherein attaching the rocker latch arm to the main barrel comprises using a retainer.

61. The method of claim 48, wherein the weatherproofing collar is formed from an elastomeric material.
